(19) United States
(12) Patent Application Publication
(10) Pub. No.: US 2023/0125451 A1
(43) Pub. Date: Apr. 27, 2023

(54) AUTOMATICALLY COORDINATED SOCIAL BUYING VIA MONITORIAL BROWSER EXTENSIONS

(71) Applicant: PayPal, Inc., San Jose, CA (US)

(72) Inventors: Robert Toledo, Los Angeles, CA (US); Kin Thai, Monterey Park, CA (US); Colin Harris McCarthy, Great Barrington, MA (US); Mark Richter, North Hollywood, CA (US); Yu Jia Chiao, Brea, CA (US)

(21) Appl. No.: 17/509,809

(22) Filed: Oct. 25, 2021

(51) Int. Cl. G06Q 30/02; G06F 11/30; G06F 11/34

(52) U.S. Cl. CPC G06Q 30/0224; G06Q 30/0222; G06Q 30/0226; G06Q 30/0225; G06Q 30/0201; G06Q 30/0211; G06F 11/302; G06F 11/3438; G06Q 30/0235

(57) ABSTRACT

Systems and techniques for facilitating automatically coordinated social buying are provided. In various embodiments, a processor can receive an electronic request from a merchant device, which identifies a team deal. In various aspects, the processor can access a plurality of transactional browsing histories that are recorded by a respectively corresponding plurality of monitorial browser extensions, with each monitorial browser extension being installed on a respectively corresponding client device. In various instances, the processor can execute a machine learning model on each transactional browsing history, thereby determining whether the transactional browsing history demonstrates interest in the team deal. In various cases, for each transactional browsing history that demonstrates interest in the team deal, the processor can invite a user of a client device corresponding to the transactional browsing history to participate in the team deal.

### TECHNICAL FIELD

The subject disclosure relates generally to coordinated social buying, and more specifically to systems and/or techniques that can facilitate automatically coordinated social buying via monitorial browser extensions.

### BACKGROUND

A coordinated social buying opportunity, which is often referred to as a team deal, is an offer by a merchant to provide a product and/or service at a discounted rate, where the offer is conditioned upon a minimum number of customers pledging to purchase the product and/or service within a specified time period. If at least the minimum number of customers pledge to purchase the product and/or service within the specified time period, the merchant honors the discounted rate for those pledged customers. However, if fewer than the minimum number of customers pledge to purchase the product and/or service within the specified time period, the merchant does not honor the discounted rate for any customer, even those pledged customers. Despite its name, coordinated social buying is rather uncoordinated when existing techniques are implemented. Specifically, when existing techniques are implemented, a merchant publishes an offer for a team deal, customers that are interested in the team deal individually contact the merchant to pledge their participation, and the merchant honors the team deal only if enough customers individually pledge their participation. Accordingly, a coordinated social buying opportunity can be considered as a type of collective action problem in which achievement of a common good (e.g., the discounted rate) depends upon the distinct behaviors (e.g., pledging participation) of multiple disorganized individuals (e.g., the customers). Unfortunately, there do not exist any systems and/or techniques that can ameliorate this collective action problem and/or that can otherwise help to facilitate more streamlined coordinated social buying.

Accordingly, systems and/or techniques that can address one or more of these problems can be desirable.

### BRIEF DESCRIPTION OF THE DRAWINGS

FIG. 1 illustrates a high-level block diagram of an example, non-limiting system that facilitates automatically coordinated social buying via monitorial browser extensions in accordance with one or more embodiments described herein.

FIG. 2 illustrates a high-level block diagram of an example, non-limiting system including a team deal promotional transaction that facilitates automatically coordinated social buying via monitorial browser extensions in accordance with one or more embodiments described herein.

FIG. 3 illustrates a high-level block diagram of an example, non-limiting system including a set of transactional browsing histories that facilitates automatically coordinated social buying via monitorial browser extensions in accordance with one or more embodiments described herein.

FIG. 4 illustrates an example, non-limiting block diagram that shows how a set of monitorial browser extensions can record a respectively corresponding set of transactional browsing histories in accordance with one or more embodiments described herein.

FIG. 5 illustrates a high-level block diagram of an example, non-limiting system including an interest-detection machine learning model that facilitates automatically coordinated social buying via monitorial browser extensions in accordance with one or more embodiments described herein.

FIG. 6 illustrates an example, non-limiting block diagram that shows how an interest-detection machine learning model can generate a set of interest/disinterest labels based on a respectively corresponding set of transactional browsing histories in accordance with one or more embodiments described herein.

FIG. 7 illustrates a high-level block diagram of an example, non-limiting system including a set of electronic invitations that facilitates automatically coordinated social buying via monitorial browser extensions in accordance with one or more embodiments described herein.

FIG. 8 illustrates a high-level flow diagram of an example, non-limiting computer-implemented method that identifies and invites interested candidates to participate in a team deal in accordance with one or more embodiments described herein.

FIG. 9 illustrates a high-level block diagram of an example, non-limiting system including a proposed team deal promotional transaction and a profitability recommendation that facilitates automatically coordinated social buying via monitorial browser extensions in accordance with one or more embodiments described herein.

FIG. 10 illustrates a high-level flow diagram of an example, non-limiting computer-implemented method that estimates profitability of a proposed team deal based on how many candidates are likely interested in the proposed team deal in accordance with one or more embodiments described herein.

FIG. 11 illustrates a high-level block diagram of an example, non-limiting system including a product/service and a team deal recommendation that facilitates automatically coordinated social buying via monitorial browser extensions in accordance with one or more embodiments described herein.

FIG. 12 illustrates a high-level flow diagram of an example, non-limiting computer-implemented method that identifies an available product/service and recommends whether a team deal regarding the available product/service would be profitable based on how many candidates are likely interested in the available product/service in accordance with one or more embodiments described herein.

FIG. 13 illustrates a high-level block diagram of an example, non-limiting system including a fraud-detection machine learning model that facilitates automatically coordinated social buying via monitorial browser extensions in accordance with one or more embodiments described herein.

FIG. 14 illustrates an example, non-limiting block diagram that shows how a fraud-detection machine learning model can generate a set of fraud/non-fraud labels based on a respectively corresponding set of transactional browsing histories in accordance with one or more embodiments described herein.

FIGS. 15-17 illustrate high-level flow diagrams of example, non-limiting computer-implemented methods that facilitate automatically coordinated social buying via monitorial browser extensions in accordance with one or more embodiments described herein.

FIG. 18 illustrates a block diagram of an example, non-limiting operating environment in which one or more embodiments described herein can be facilitated.

FIG. 19 illustrates an example networking environment operable to execute various implementations described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background section, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A coordinated social buying opportunity, which can also be referred to as a team deal and/or a team deal promotional transaction, can be an offer by a merchant to provide a product and/or service at a discounted rate (and/or with some other promotional benefit), where the offer is conditioned and/or otherwise contingent upon a minimum number of customers pledging to purchase the product and/or service within a specified time period. If at least the minimum number of customers pledge to purchase the product and/or service within the specified time period, the merchant can honor the discounted rate for those pledged customers. However, if fewer than the minimum number of customers pledge to purchase the product and/or service within the specified time period, the merchant can refuse to honor the discounted rate for any customer, even those pledged customers. As an example, suppose that a smart phone vendor offers to sell smart phones at a $200.00 discount provided that at least one thousand customers pledge to purchase smart phones from the smart phone vendor within one week from publication of the offer. If at least one thousand customers pledge to purchase the smart phones within one week from publication of the offer, the smart phone vendor can proceed to sell smart phones to those pledged customers at the $200.00 discount. On the other hand, if fewer than one thousand customers pledge to purchase the smart phones within one week from publication of the offer, the smart phone vendor can refuse to sell smart phones at the $200.00 discount to any customers.

Despite its name, coordinated social buying can be rather uncoordinated when existing techniques are implemented. Specifically, when existing techniques are implemented, a merchant can publish an offer for a team deal, various customers that are interested in the team deal can individually contact the merchant to pledge their participation in the team deal, and the merchant can refuse to honor the team deal unless enough customers individually pledge their participation. The customers can often be disparate and/or separate entities that have no prior relationships with and/or even knowledge of each other. Moreover, it can often be the case that many customers who would not be interested in the team deal notice the publication and/or otherwise learn of the team deal, while many other customers who would be interested in the team deal fail to notice the publication and/or otherwise fail to learn of the team deal. Furthermore, even if an interested customer notices the publication and/or otherwise learns of the team deal, it can often be the case that the interested customer resolves to pledge his/her participation in the team deal and then subsequently forgets to follow through. For at least these reasons, a team deal can be considered as a type of collective action problem in which achievement of a common good (e.g., the discounted rate of the team deal) depends upon the distinct behaviors (e.g., pledging participation) of multiple disorganized individuals (e.g., the customers). Unfortunately, there do not exist any systems and/or techniques that can ameliorate this collective action problem and/or that can otherwise help to facilitate more streamlined team deals.

Accordingly, systems and/or techniques that can address one or more of these problems can be desirable.

Various embodiments described herein can address one or more of these technical problems. One or more embodiments described herein include systems, computer-implemented methods, apparatus, and/or computer program products that can facilitate automatically coordinated social buying via monitorial browser extensions. In other words, various embodiments described herein can include a computerized tool (e.g., any suitable combination of computer-executable hardware and/or computer-executable software) that can be electronically integrated with a set of monitorial browser extensions and that can electronically leverage the set of monitorial browser extensions so as to coordinate and/or otherwise facilitate a team deal in a streamlined fashion.

In various embodiments, a computerized tool as described herein can comprise a set of monitorial browser extensions, a receiver component, a history component, an interest component, and/or an execution component.

In various aspects, the set of monitorial browser extensions can include any suitable number of monitorial browser extensions. As those having ordinary skill in the art will appreciate, a browser extension can be a software module (e.g., computer-executable software) that can be installed on and/or otherwise appended to a web browser (e.g., Chrome®, Safari®, Mozilla Firefox®, Internet Explorer®, Microsoft Edge®) of a computing device (e.g., smart phone, laptop computer, desktop computer), so as to augment the functionality of the web browser. More specifically, a monitorial browser extension can be a software module that can be installed on and/or otherwise appended to a web browser of a computing device, where such software module can electronically monitor, log, document, note, and/or otherwise record the transactional browsing activity of the web browser. That is, a monitorial browser extension can track in chronological order (and/or in any other suitable order) the e-commerce webpages that a web browser visits (e.g., the monitorial browser extension can capture in real time each uniform resource locator (URL) that is associated with e-commerce and that is visited by the web browser). Moreover, in various cases, a monitorial browser extension can track in chronological order (and/or in any other suitable order) the specific electronic actions taken by the web browser when visiting various e-commerce webpages (e.g., when the web browser visits a particular e-commerce web page, the monitorial browser extension can capture in real time which user interface elements of the particular e-commerce webpage are clicked and/or otherwise invoked by the web browser). As a non-limiting example, the Honey® browser extension can be considered as a monitorial browser extension (e.g., when installed on a web browser, the Honey® browser extension can monitor the e-commerce and/or online shopping activity of the web browser).

In various instances, the set of monitorial browser extensions can be installed on a respectively corresponding set of client devices. That is, each monitorial browser extension can be electronically installed on and/or otherwise appended to a web browser of a respectively corresponding client device, so as to monitor, log, document, note, and/or otherwise record the transactional web browsing activity (e.g., online shopping activity and/or e-commerce activity, as opposed to general web browsing activity) of that respectively corresponding client device. In various cases, a client device can be any suitable computing device (e.g., smart phone, laptop computer, desktop computer) that is owned and/or operated by a user (e.g., by an e-commerce customer). Accordingly, when a monitorial browser extension is installed on a web browser of a client device, the monitorial browser extension can be considered as monitoring, logging, documenting, noting, and/or otherwise recording a transactional browsing history of a user of the client device. Thus, the set of monitorial browser extensions can collectively be considered as tracking and/or capturing a respectively corresponding set of transactional browsing histories.

In various aspects, there can be a merchant device. In various instances, the merchant device can be any suitable computing device (e.g., smart phone, laptop computer, desktop computer) that is owned and/or operated by a merchant. In various cases, the merchant that owns and/or operates the merchant device can desire to offer a team deal. That is, the merchant can desire to offer a product/service at a discounted rate, provided that a minimum number of customers pledge to purchase the product/service within a specified time period. In various instances, the computerized tool can utilize the set of monitorial browser extensions so as to electronically coordinate and/or facilitate the team deal, as described herein.

In various embodiments, the receiver component of the computerized tool can electronically receive and/or otherwise electronically access, from the merchant device, an electronic request that identifies the team deal. In various instances, the electronic request can specify any suitable details regarding the team deal. For example, the electronic request can indicate which specific product and/or service the team deal pertains to, the unit cost to the merchant of such product and/or service, what specific discounted price the merchant is offering to sell the product and/or service at, a minimum amount of profit that the merchant desires to earn, the minimum number of customers that are required to complete the team deal, and/or a specified time period during which the team deal is active.

In various cases, the receiver component can electronically retrieve the electronic request from the merchant device. In various other cases, the receiver component can electronically retrieve the electronic request from any other suitable data structure (e.g., graph data structure, relational data structure, hybrid data structure) that is electronically accessible to the receiver component, whether the data structure is centralized and/or decentralized, and/or whether the data structure is remote from and/or local to the receiver component. In any case, the receiver component can electronically access the electronic message that identifies details of the team deal, so that other components of the computerized tool can electronically interact with (e.g., read, write, copy, edit, analyze) such details of the team deal.

As those having ordinary skill in the art will appreciate, the electronic request can indicate the details of the team deal in any suitable data format. For example, the electronic request can represent the details of the team deal via one or more scalars, one or more vectors, one or more matrices, one or more tensors, one or more character strings, and/or any suitable combination thereof.

In various embodiments, the history component of the computerized tool can electronically receive and/or otherwise electronically access the set of transactional browsing histories that are captured by the set of monitorial browser extensions. As mentioned above, the set of transactional browsing histories can respectively correspond to the set of client devices, such that a given transactional browsing history can represent the transactional browsing activity and/or transactional browsing behavior of a respectively corresponding client device and thus of a respectively corresponding user (e.g., customer). In some cases, the history component can electronically retrieve the set of transactional browsing histories from the set of monitorial browser extensions. That is, each monitorial browser extension can electronically transmit the transactional browsing history that it has tracked/captured to the history component. In other cases, the history component can electronically retrieve the set of transactional browsing histories from any other suitable data structure that is electronically accessible to the history component, whether the data structure is centralized and/or decentralized, and/or whether the data structure is remote from and/or local to the history component. That is, each monitorial browser extension can electronically transmit the transactional browsing history that is has tracked/captured to any suitable computing device, and the history component can retrieve such transactional browsing history from such computing device. In any case, the history component can electronically access and/or obtain the set of transactional browsing histories that have been respectively logged by the set of monitorial browser extensions.

In various embodiments, the interest component of the computerized tool can electronically store, maintain, control, and/or otherwise operate an interest-detection machine learning model. In various aspects, the interest-detection machine learning model can exhibit any suitable artificial intelligence architecture. For example, in some cases, the interest-detection machine learning model can exhibit a deep learning architecture. That is, the interest-detection machine learning model can include any suitable number of neural network layers, any suitable numbers of neurons in various layers (e.g., different layers can have different numbers of neurons), any suitable activation functions (e.g., sigmoid, softmax, hyperbolic tangent, rectified linear unit), and/or any suitable interneuron connectivity patterns (e.g., forward connections, skip connections, recursive connections). In other cases, the interest-detection machine learning model can exhibit any other suitable artificial intelligence architecture as desired (e.g., support vector machine, logistic regression model, naive Bayes model).

In various aspects, the interest-detection machine learning model can be configured so as to receive as input a given transactional browsing history and details regarding the team deal, and to generate as output a binary classification that indicates whether or not the given transactional browsing history demonstrates, suggests, and/or otherwise indicates interest in the team deal. More specifically, as mentioned above, the details regarding the team deal can be formatted as one or more scalars, vectors, matrices, tensors, and/or character strings. Similarly, the given transactional browsing history can likewise be formatted as one or more scalars, vectors, matrices, tensors, and/or character strings. In cases where the interest-detection machine learning model exhibits a deep learning architecture, an input layer of the interest- detection machine learning model can be configured to receive the scalars, vectors, matrices, tensors, and/or character strings that represent the team deal and to also receive the scalars, vectors, matrices, tensors, and/or character strings that represent the given transactional browsing history. In various instances, these inputs can complete a forward pass through one or more hidden layers of the interest-detection machine learning model. In various aspects, based on activations generated by the one or more hidden layers during the forward pass, an output layer of the interest-detection machine learning model can produce a scalar, where the magnitude of the scalar (e.g., between 0 and 1, inclusively) represents a level and/or likelihood of interest in the team deal that is exhibited and/or demonstrated by the given transactional browsing history. As a non-limiting example, higher magnitudes of the scalar (e.g., magnitudes closer to 1) produced by the output layer can indicate that the user/customer who created the given transactional browsing history is more interested and/or more likely to be interested in the team deal. In contrast, lower magnitudes of the scalar (e.g., magnitudes closer to 0) produced by the output layer can indicate that the user/customer who created the given transactional browsing history is less interested and/or less likely to be interested in the team deal. In various aspects, if the scalar is above any suitable threshold value (e.g., 0.5), the interest-detection machine learning model can infer that the given transactional browsing history demonstrates sufficiently high interest in the team deal (e.g., can infer that the user/customer that corresponds to the given transactional browsing history would want to participate in the team deal). On the other hand, if the scalar is below any suitable threshold value, the interest-detection machine learning model can infer that the given transactional browsing history demonstrates insufficiently high interest in the team deal (e.g., can infer that the user/customer that corresponds to the given transactional browsing history would not want to participate in the team deal).

As those having ordinary skill in the art will appreciate, the interest-detection machine learning model can be trained via any suitable learning paradigm (e.g., supervised training, unsupervised training, reinforcement learning) to perform such functionality. As an example, the interest-detection machine learning model can be trained on a first training dataset. In various cases, the first training dataset can include a set of annotated team-deal-and-browsing-history tuples. In various instances, each annotated team-deal-and-browsing-history tuple can include one or more scalars, vectors, matrices, tensors, and/or character strings that define a team deal and can also include one or more scalars, vectors, matrices, tensors, and/or character strings that define a transactional browsing history. Moreover, each annotated team-deal-and-browsing-history tuple can respectively correspond to a ground-truth label that represents a known and/or correct interest classification for that annotated team-deal-and-browsing-history couple. For example, if a particular transactional browsing history is known to demonstrate interest in a particular team deal, then an annotated tuple that represents that particular transactional browsing history and that particular team deal can correspond to a ground-truth label of “interested.” In contrast, if a particular transactional browsing history is known to not demonstrate interest in a particular team deal, then an annotated tuple that represents that particular transactional browsing history and that particular team deal can correspond to a ground-truth label of “disinterested.” As those having ordinary skill in the art will appreciate, iterative backpropagation can be facilitated bin a supervised fashion based on the first training dataset, such that internal parameters (e.g., weights, biases) of the interest-detection machine learning model become optimized for inferring interest in an inputted team deal that is exhibited by an inputted transactional browsing history.

After the interest-detection machine learning model has been trained and/or configured, the interest component of the computerized tool can electronically execute and/or inference the interest-detection machine learning model on each of the set of transactional browsing histories that have been obtained/accessed by the history component. The result can be a set of interest/disinterest labels that respectively correspond to the set of transactional browsing histories. In other words, for each transactional browsing history in the set of transactional browsing histories, the interest-detection machine learning model can infer whether or not the transactional browsing history demonstrates interest in the team deal. If so, the interest-detection machine learning model can classify the transactional browsing history as being “interested.” If not, the interest-detection machine learning machine learning model can instead classify the transactional browsing history as being “disinterested.” In any case, the interest component can execute the interest-detection machine learning model on each of the set of transactional browsing histories, thereby yielding the set of interest/disinterest labels.

In various embodiments, the execution component of the computerized tool can electronically iterate through each of the set of transactional browsing histories. More specifically, for each transactional browsing history in the set of transactional browsing histories, the execution component can electronically identify, in the set of interest/disinterest labels, an interest/disinterest label that corresponds to the transactional browsing history under consideration. If the identified interest/disinterest label indicates that the transactional browsing history under consideration does not demonstrate interest in the team deal, the execution component can move on to the next transactional browsing history in the set of transactional browsing histories. On the other hand, if the identified interest/disinterest label instead indicates that the transactional browsing history under consideration demonstrates interest in the team deal, the execution component can electronically transmit an electronic message to a client device that corresponds to the transactional browsing history under consideration (e.g., to the client device to which the generated transactional browsing history belongs). In various cases, the execution component can then move on to the next transactional browsing history in the set of transactional browsing histories.

In various instances, the electronic message can invite a user of the client device to participate in the team deal. For example, the electronic message can specify various details of the team deal, such as the specific product/service that is the focus of the team deal, the specific price discount that is being offered in the team deal, how many customers are required to complete the team deal, a time/date at which the team deal expires/ends, and/or instructions for how to pledge participation in the team deal.

In various cases, the execution component can estimate and/or compute, via any suitable computational algorithm and/or artificial intelligence technique, an amount of reward points based on the transactional browsing history under consideration, and the electronic message can specify, as an incentive to participate in the team deal, that receipt of the amount of reward points is conditioned and/or contingent on participation in the team deal. That is, if the user of the client device does not participate in the team deal, the user of the client device cannot receive the estimated/computed amount of reward points. In various cases, the amount of reward points can be inversely proportional with the level and/or likelihood of interest in the team deal that is demonstrated by the transactional browsing history under consideration. That is, if the transactional browsing history under consideration suggests a higher level and/or higher likelihood of interest in the team deal (e.g., as compared to any suitable threshold), the execution component can estimate and/or compute a smaller amount of reward points, since a user that is already highly interested in the team deal does not need a large amount of reward points for incentive. In contrast, if the transactional browsing history under consideration suggests a lower level and/or lower likelihood of interest in the team deal, the execution component can estimate and/or compute a larger amount of reward points, since a user that is not already highly interested in the team deal may need a large amount of reward points for incentive.

In various aspects, the electronic message can further prompt the user of the client device to share the electronic message with one or more other people (e.g., with friends and/or family). Indeed, in some cases, the execution component can identify within the transactional browsing history under consideration one or more other computing devices with which the client device that corresponds to the transactional browsing history under consideration has electronically communicated, and the electronic message can suggest that the user share the electronic message with such one or more other computing devices. In some cases, the execution component can even transmit the electronic message to those one or more other computing devices. As a non-limiting example, suppose that the transactional browsing history under consideration was generated by a mobile phone A. Moreover, suppose that the transactional browsing history under consideration shows email correspondence between the mobile phone A and a laptop computer B, and also shows social media correspondence between the mobile phone A and a desktop computer C. In such case, the execution component can, in some instances, transmit the electronic message to the mobile phone A, and the electronic message can suggest that the user of the mobile phone A share the electronic message with the laptop computer B and/or the desktop computer C. In other instances, the execution component can electronically transmit the electronic message to the mobile phone A, the laptop computer B, and/or the desktop computer C.

In cases where the electronic message prompts sharing with other computing devices and/or is transmitted to other computing devices by the execution component, the electronic message can further include a hyperlink. In various aspects, the hyperlink can be configured such that invocation of the hyperlink (e.g., clicking on the hyperlink) by a given computing device causes the execution component (and/or any other server, as desired) to determine whether or not the given computing device already has a monitorial browser extension installed on it. If the given computing device does not already have a monitorial browser extension installed, the execution component (and/or the any other server) can electronically download and/or install (and/or request permission to download/install) a monitorial browser extension on the given computing device, thereby increasing the size of the set of monitorial browser extensions.

That is, in various aspects, the computerized tool described herein can electronically leverage the set of monitorial browser extensions so as to identify customers who are likely to be interested in the team deal, and the computerized tool can subsequently interact with such customers to encourage them to participate in the team deal. In this way, the computerized tool can be considered as automatically coordinating and/or organizing participation in the team deal.

In various embodiments, the merchant that owns/operates the merchant device can have not actually offered the team deal yet. Instead, the merchant can be contemplating whether or not to officially offer the team deal. In such case, the computerized tool can be utilized to help the merchant to make this decision. Specifically, the receiver component can electronically receive and/or access, from the merchant device, an electronic request that identifies details of a proposed team deal. Just as above, the history component can electronically access the set of transactional browsing histories that are logged by the set of monitorial browser extensions, and the interest component can electronically execute the interest-detection machine learning model on each of the set of transactional browsing histories. That is, for each transactional browsing history in the set of transactional browsing histories, the interest component can feed as input to the interest-detection machine learning model both one or more scalars, vectors, matrices, tensors, and/or character strings that represent the transactional browsing history and one or more scalars, vectors, matrices, tensors, and/or character strings that represent the proposed team deal. This can cause the interest-detection machine learning model to generate as output the set of interest/disinterest labels, where each interest/disinterest label indicates whether or not a respectively corresponding transactional browsing history from the set of transactional browsing histories demonstrates sufficient interest in the proposed team deal.

In such case, the execution component can electronically count how many interest/disinterest labels indicate sufficient interest in the proposed team deal. If the execution component determines that at least a threshold number of transactional browsing histories demonstrate interest in the proposed team deal, the execution component can conclude that the proposed team deal would be profitable (e.g., that the expected profit of the proposed team deal meets and/or exceeds a minimum amount of profit desired by the merchant). On the other hand, if the execution component determines that fewer than a threshold number of transactional browsing histories demonstrate interest in the proposed team deal, the execution component can conclude that the proposed team deal would not be profitable (e.g., that the expected profit of the proposed team deal falls below a minimum amount of profit desired by the merchant). In any case, the execution component can electronically transmit to the merchant device an electronic recommendation that specifies and/or indicates whether or not the proposed team deal would be profitable.

In some cases, if the execution component determines that the proposed team deal would not be profitable, this can indicate that too few transactional browsing histories, and thus too few customers, demonstrate interest in the product/service that is involved in the proposed team deal. In such instances, the execution component can electronically estimate, via any suitable computational algorithm and/or artificial intelligence technique, a new discounted price based on how many of the set of transactional browsing histories demonstrate interest in the proposed team deal, where implementing the proposed team deal at the new discounted price would make the proposed team deal profitable (e.g., would net at least the desired amount of profit when given the number of transactional browsing histories that currently demonstrate interest in the product/service of the proposed team deal). In various aspects, the electronic message that is transmitted to the merchant device can specify and/or indicate such new discounted price.

That is, in various aspects, the computerized tool described herein can electronically leverage the set of monitorial browser extensions so as to identify customers who are likely to be interested in a proposed team deal, and the computerized tool can subsequently determine whether the proposed team deal would be sufficiently profitable based on how many customers are likely to be interested in the proposed team deal. In this way, the computerized tool can be of great use to a merchant that is deciding whether or not to offer a proposed team deal.

In various embodiments, it can be the case that the merchant that owns/operates the merchant device has not officially offered a team deal and is not currently contemplating a proposed team deal. In such case, the computerized tool can be utilized to help the merchant nonetheless. Specifically, the receiver component can electronically receive and/or access, from the merchant device, an electronic inventory of the merchant. In other words, the receiver component can electronically identify a product and/or service that is available according to the electronic inventory of the merchant. In various instances, the receiver component can identify any suitable details regarding the product/service. Just as above, the history component can electronically access the set of transactional browsing histories that are logged by the set of monitorial browser extensions, and the interest component can electronically execute the interest-detection machine learning model on each of the set of transactional browsing histories. That is, for each transactional browsing history in the set of transactional browsing histories, the interest component can feed as input to the interest-detection machine learning model both one or more scalars, vectors, matrices, tensors, and/or character strings that represent the transactional browsing history and one or more scalars, vectors, matrices, tensors, and/or character strings that represent the product/service. This can cause the interest-detection machine learning model to generate as output the set of interest/disinterest labels, where each interest/disinterest label indicates whether or not a respectively corresponding transactional browsing history from the set of transactional browsing histories demonstrates sufficient interest in the product/service.

In such case, the execution component can electronically count how many interest/disinterest labels indicate sufficient interest in the product/service. If the execution component determines that at least a threshold number of transactional browsing histories demonstrate interest in the product/service, the execution component can conclude that a team deal regarding the product/service would be profitable. On the other hand, if the execution component determines that fewer than a threshold number of transactional browsing histories demonstrate interest in the product/service, the execution component can conclude that a team deal regarding the product/service would not be profitable. If the execution component determines that a team deal regarding the product/service would be profitable, the execution component can electronically transmit to the merchant device an electronic recommendation that specifies and/or indicates that offering a team deal for the product/service would be profitable. In various aspects, the electronic message can indicate and/or specify how many transactional browsing histories, and thus how many customers, demonstrate interest in the product/service. In some cases, the execution component can compute, based on how many transactional browsing histories demonstrated interest in the product/service and via any suitable computational algorithm and/or artificial intelligence technique, a minimum price (e.g., a maximum discount) at which the product/service can be offered while still being profitable. In various instances, the electronic message can indicate such minimum price.

That is, in various aspects, the computerized tool described herein can electronically leverage the set of monitorial browser extensions so as to identify customers who are likely to be interested in any suitable product/service that is available in an inventory of the merchant, and the computerized tool can subsequently determine whether offering a team deal for that product/service would be sufficiently profitable based on how many customers are likely to be interested in the product/service. In this way, the computerized tool can be of great use to a merchant, even if the merchant has not requested an analysis of a proposed team deal.

Therefore, various embodiments described herein include a computerized tool that can leverage a set of monitorial browsing extensions and one or more trained machine learning models to facilitate improved coordination and/or facilitation of team deals.

Various embodiments described herein can be employed to use hardware and/or software to solve problems that are highly technical in nature (e.g., to facilitate automatically coordinated social buying via monitorial browser extensions), that are not abstract and that cannot be performed as a set of mental acts by a human. Further, some of the processes performed can be performed by a specialized computer (e.g., trained machine learning models, monitorial browser extensions) for carrying out defined tasks related to automatically coordinated social buying via monitorial browser extensions.

For example, some defined tasks of various embodiments described herein can include: electronically identifying a team deal, electronically accessing a set of transactional browsing histories that are recorded by a respectively corresponding set of monitorial browser extensions, where each monitorial browser extension is installed on a web browser of a respectively corresponding client device; electronically executing an interest-detection machine learning model on each of the set of transactional browsing histories, thereby yielding a set of interest/disinterest labels; and initiating various electronic actions based on the set of interest/disinterest labels (e.g., transmitting electronic messages to client devices that have transactional browsing histories demonstrating interest in the team deal, and/or estimating profitability of the team deal based on how many transactional browsing histories demonstrate interest in the team deal).

Such defined tasks are not performed manually by humans. Indeed, neither the human mind nor a human with pen and paper can electronically retrieve information pertaining to a team deal, electronically retrieve transactional browsing histories recorded by various monitorial browser extensions that are installed on the web browsers of various computing devices, electronically execute a trained machine learning model on such transactional browsing histories, and electronically transmit messages and/or recommendations based on the results outputted by the trained machine learning model. Instead, various embodiments described herein are inherently and inextricably tied to computer technology and cannot be implemented outside of a computing environment (e.g., monitorial browser extensions and machine learning models are inherently computerized objects that cannot be implemented in any sensible, reasonable, or practical way without computers; accordingly, a computerized tool that utilizes monitorial browser extensions and machine learning models to improve the coordination of team deals is also an inherently computerized object that cannot be implemented in any sensible, reasonable, or practical way without computers).

Moreover, it must be emphasized that the fact that various embodiments described herein can be implemented to improve coordination and/or streamlining of real-world team deals (e.g., coordinated social buying) does not reduce such embodiments to mere techniques of organizing human activity. As described thoroughly herein, various embodiments include a computerized tool that performs specific computerized computations/actions via specific computer hardware/software. Such specific computer hardware/software can include a computer-readable memory, a computer processor, a set of monitorial browser extensions that are installed on a respectively corresponding set of computing devices, and one or more trained machine learning classifiers. In various cases, the computerized tool can obtain a set of online transactional browsing histories that are tracked/recorded by the set of monitorial browser extensions, the computerized tool can execute the one or more trained machine learning classifiers on such online transactional browsing histories, and the computerized tool can initiate one or more electronic actions (e.g., generation and/or transmission of electronic messages with specified content) based on the results generated by such one or more machine learning classifiers. In the real-world, a practical benefit of the herein-described embodiments can be realized via implementation in the field of coordinated social buying (e.g., to help identify customers that are interested in team deals). However, this does not change the inherently-computerized nature of such embodiments (e.g., monitorial browser extensions and/or trained machine learning classifiers are specific and/or specialized computer hardware/software that simply cannot be implemented by humans alone). Furthermore, it must also be pointed out that the ultimate goal of all technological innovation is to aid the human experience and/or human activity. Therefore, the mere fact that various embodiments described herein can be implemented to benefit human activity (e.g., to improve the coordination/streamlining of team deals) does not erase the specific computerized and/or technical nature of such embodiments.

In various instances, embodiments described herein can integrate into a practical application the disclosed teachings regarding automatically coordinated social buying via monitorial browser extensions. As explained above, there do not exist any systems/techniques that can help to make team deals more coordinated and/or streamlined. Accordingly, the inventors of various embodiments described herein devised a solution to this problem. Specifically, the inventors recognized that online transactional browsing histories can contain rich information that can indicate whether a given customer is interested or disinterested in a given team deal. Accordingly, the computerized tool as described herein can include and/or be integrated with a set of monitorial browser extensions that are electronically installed on the web browsers of a respectively corresponding set of customer devices. In various cases, the computerized tool can access information regarding a team deal that is being offered by a merchant, and the computerized tool can also access online transactional browsing histories that are recorded by the set of monitorial browser extensions. In various instances, the computerized tool can execute an interest-detection machine learning model on each of the online transactional browsing histories, thereby classifying each online transactional browsing history as either interested in or disinterested in the team deal. Accordingly, the computerized tool can take specific computerized actions for each online transactional browsing history that is classified as demonstrating interest in the team deal (e.g., can invite a user of the customer device that generated such online transactional browsing history to participate in the team deal, can offer reward points as an incentive to participate in the team deal). Such a computerized tool can improve the coordination and/or streamlining of a real-world team deal. Thus, such a computerized tool constitutes a concrete and tangible technical improvement in the field of coordinated social buying and is thus certainly a useful and practical application of computers.

Moreover, in various aspects, embodiments described herein can control real-world and/or tangible devices based on the disclosed teachings. For example, a computerized tool as described herein can electronically communicate with real-world monitorial browser extensions, can electronically train and/or execute real-world machine learning classifiers, and/or can electronically generate and/or transmit real-world electronic messages.

It should be appreciated that the figures described herein are non-limiting examples of various embodiments.

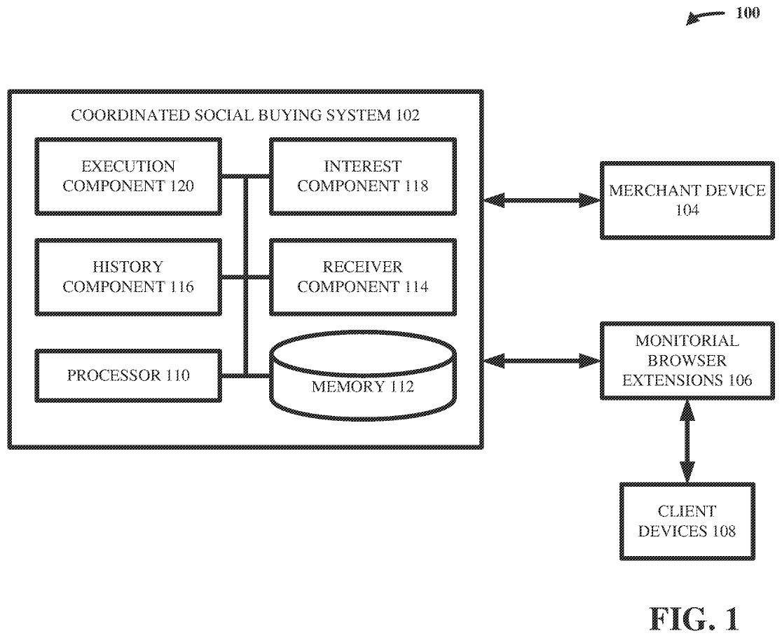

FIG. 1 illustrates a high-level block diagram of an example, non-limiting system 100 that can facilitate automatically coordinated social buying via monitorial browser extensions in accordance with one or more embodiments described herein. As shown, a coordinated social buying system 102 can be electronically integrated, via any suitable wired and/or wireless electronic connections, with a merchant device 104 and/or with a set of monitorial browser extensions 106.

In various aspects, the merchant device 104 can be any suitable computing device that is owned by, operated by, controlled by, and/or otherwise associated with a merchant (e.g., a seller/vendor of products and/or services). As some non-limiting examples, the merchant device 104 can be a laptop computer of the merchant, a desktop computer of the merchant, a smart phone of the merchant, and/or a point-of-sale device of the merchant.

In various instances, the set of monitorial browser extensions 106 can include any suitable number of monitorial browser extensions. As those having ordinary skill in the art will understand, a monitorial browser extension can be any suitable computer-executable software module that can be electronically installed on a web browser and that can electronically monitor, log, document, note, record, and/or otherwise track the transactional browsing activity of the web browser. That is, a monitorial browser extension that is installed on a web browser can electronically capture the URLs of specific webpages that are visited by the web browser and/or can electronically capture the electronic actions taken by the web browser when visiting specific webpages (e.g., can track how the web browser interacted with a scroll bar of a webpage, how the web browser interacted with clickable buttons of a webpage, how the web browser interacted with clickable links of a webpage). Thus, a monitorial browser extension can track all and/or any suitable subset of the online transactional browsing behavior and/or online transactional browsing activity of the web browser. Moreover, because the monitorial browser extension is installed on the web browsers, the monitorial browser extension can track the web browser's activity across any and/or all websites visited by the web browser (e.g., two or more websites). Those having ordinary skill in the art will appreciate that this multi-website monitorial functionality greatly distinguishes a monitorial browser extension from web cookies (e.g., web cookies are implemented by an individual website to save webpages and/or web states generated by that specific website during a visit by a web browser to that specific website; in contrast, a monitorial browser extension is installed on the web browser and can track all of the web browser's activities across all and/or any suitable subset of websites that are visited by the web browser).

In various aspects, the set of monitorial browser extensions 106 can be respectively installed on a set of client devices 108. That is, for each given monitorial browser extension in the set of monitorial browser extensions 106, there can be a unique client device in the set of client devices 108 that respectively corresponds to the given monitorial browser extension, such that the given monitorial browser extension is electronically installed on a web browser of the unique client device, and such that the given monitorial browser extension can monitor, log, document, note, record, and/or otherwise track the transactional browsing activity/behavior of the unique client device. In various instances, a client device can be any suitable computing device that is owned by, operated by, controlled by, and/or otherwise associated with a client (e.g., a buyer and/or customer of products and/or services). As some non-limiting examples, a client device can be a laptop computer of a client/customer, a desktop computer of a client/customer, a smart phone of a client/customer, and/or a smart watch of a client/customer.

In various instances, the merchant device 104 can have access to various information regarding a team deal promotional transaction, and the coordinated social buying system 102 can leverage the set of monitorial browser extensions 106 so as to facilitate and/or coordinate the team deal promotional transaction, as described herein.

In various embodiments, the coordinated social buying system 102 can comprise a processor 110 (e.g., computer processing unit, microprocessor) and a computer-readable memory 112 that is operably coupled to the processor 110. The memory 112 can store computer-executable instructions which, upon execution by the processor 110, can cause the processor 110 and/or other components of the coordinated social buying system 102 (e.g., receiver component 114, history component 116, interest component 118, execution component 120) to perform one or more acts. In various embodiments, the memory 112 can store computer-executable components (e.g., receiver component 114, history component 116, interest component 118, execution component 120), and the processor 110 can execute the computer-executable components.

In various embodiments, the coordinated social buying system 102 can comprise a receiver component 114. In various aspects, the receiver component 114 can electronically receive and/or otherwise electronically access electronic data defining a team deal promotional transaction. In some cases, the receiver component 114 can retrieve the electronic data defining the team deal promotional transaction from the merchant device 104. In other cases, the receiver component 114 can retrieve the electronic data defining the team deal promotional transaction from any other suitable computing device (not shown), as desired. In any case, the receiver component 114 can electronically obtain and/or access the electronic data defining the team deal promotional transaction, such that other components of the coordinated social buying system 102 can electronically interact with such electronic data.

In various embodiments, the coordinated social buying system 102 can comprise a history component 116. In various aspects, the history component 116 can electronically receive and/or otherwise electronically access a set of transactional browsing histories that are recorded and/or captured by the set of monitorial browser extensions 106. As mentioned above, each of the set of monitorial browser extensions 106 can be installed on a web browser of a respectively corresponding one of the set of client devices 108, so that each monitorial browser extension can electronically record and/or capture the browser activity/behavior of the client device on which it is installed. Accordingly, the set of monitorial browser extensions 106 can collectively record a respectively corresponding set of transactional browsing histories, and the history component 116 can electronically access such set of transactional browsing histories. In some cases, the history component 116 can retrieve the set of transactional browsing histories from the set of monitorial browser extensions 106. In other cases, the history component 116 can retrieve the set of transactional browsing histories from any other suitable computing device (not shown), as desired.

In various embodiments, the coordinated social buying system 102 can comprise an interest component 118. In various aspects, the interest component 118 can electronically store, maintain, operate, and/or otherwise control an interest-detection machine learning model. In various instances, the interest-detection machine learning model can exhibit any suitable artificial intelligence architecture, as desired. Moreover, in various cases, the interest-detection machine learning model can be configured and/or trained to receive as input both a given transactional browsing history and the electronic data defining the team deal promotional transaction, and the interest-detection machine learning model can be configured and/or trained to produce as output a label that classifies the given transactional browsing history as either demonstrating a threshold level of interest in the team deal promotional transaction or failing to demonstrate the threshold level of interest in the team deal promotional transaction. Accordingly, in various aspects, the interest component 118 can electronically execute the interest-detection machine learning model on each of the set of transactional browsing histories obtained/accessed by the history component 116, which can thereby yield a set of interest/disinterest labels that respectively correspond to the set of transactional browsing histories.

In various embodiments, the coordinated social buying system 102 can comprise an execution component 120. In various aspects, the execution component 120 can initiate various electronic actions based on the set of interest/disinterest labels generated by the interest component 118. For example, in some cases, the execution component 120 can iterate through each of the set of transactional browsing histories accessed by the history component 116. For each transactional browsing history, the execution component 120 can electronically transmit an electronic message to a client device that corresponds to and/or that generated the transactional browsing history, provided that the transactional browsing history has an interest/disinterest label indicating sufficient interest in the team deal promotional transaction. In such cases, the electronic message can invite a user of the client device to participate in the team deal promotional transaction. As another example, in other cases, the execution component 120 can count how many transactional browsing histories have interest/disinterest labels indicating sufficient interest in the team deal promotional transaction. If the execution component 120 determines that more than a threshold number of transactional browsing histories demonstrate interest in the team deal promotional transaction, the execution component 120 can electronically transmit an electronic recommendation to the merchant device 104, where the electronic recommendation indicates that the team deal promotional transaction is likely to be profitable. On the other hand, if the execution component 120 determines that fewer than a threshold number of transactional browsing histories demonstrate interest in the team deal promotional transaction, the execution component 120 can electronically transmit an electronic recommendation to the merchant device 104, where the electronic recommendation indicates that the team deal promotional transaction is not likely to be profitable. In any case, the execution component 120 can initiate various computerized actions based on the set of interest/disinterest labels generated by the interest component 118, where such computerized actions can help to facilitate and/or coordinate the team deal promotional transaction.

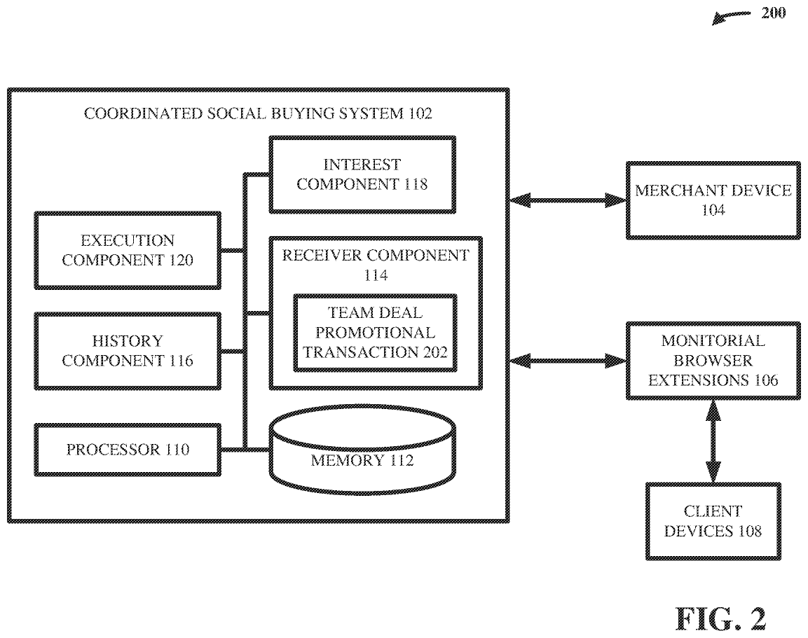

FIG. 2 illustrates a high-level block diagram of an example, non-limiting system 200 including a team deal promotional transaction that can facilitate automatically coordinated social buying via monitorial browser extensions in accordance with one or more embodiments described herein. As shown, the system 200 can, in some cases, comprise the same components as the system 100, and can further comprise electronic data defining a team deal promotional transaction 202.

In various embodiments, the receiver component 114 can electronically receive, retrieve, and/or access, from the merchant device 104, electronic data defining the team deal promotional transaction 202. In various instances, the electronic data can specify, indicate, and/or otherwise represent any suitable details regarding the team deal promotional transaction 202. For example, the electronic data can specify a product and/or service that is the subject of the team deal promotional transaction 202. As another example, the electronic data can specify a per-unit cost that the merchant that owns/operates the merchant device 104 incurs for such product/service. As yet another example, the electronic data can specify a discounted per-unit price at which the merchant is offering such product/service. As still another example, the electronic data can specify a minimum number of customers that must participate in the team deal promotional transaction 202 in order for the discounted per-unit price to be applied. As another example, the electronic data can specify a time period during which the team deal promotional transaction 202 is and/or will be active. As yet another example, the electronic data can specify instructions for pledging participation in the team deal promotional transaction 202.

As those having ordinary skill in the art will appreciate, in various aspects, the electronic data defining the team deal promotional transaction 202 can exhibit any suitable format. For example, the electronic data defining the team deal promotional transaction 202 can be configured and/or formatted as one or more scalars, one or more vectors, one or more matrices, one or more tensors, one or more character strings, and/or any suitable combination thereof.

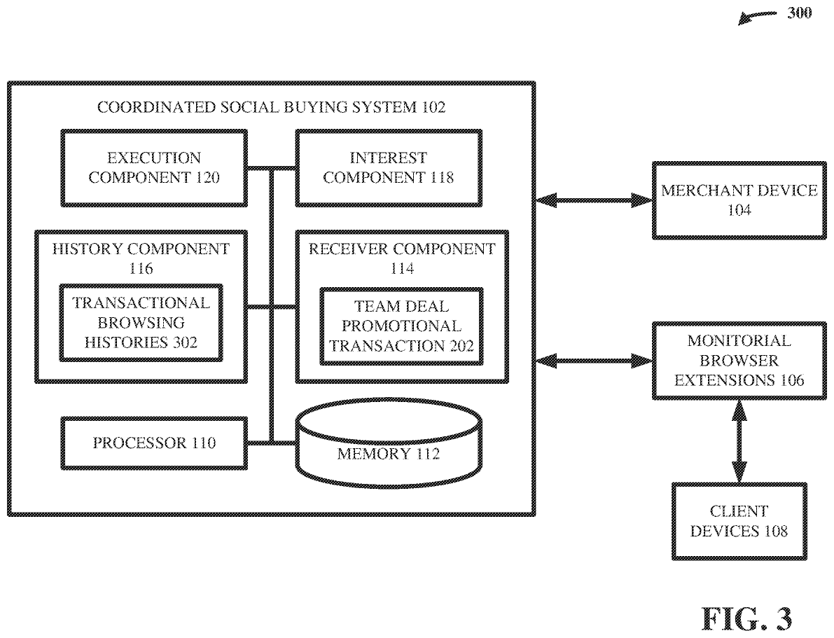

FIG. 3 illustrates a high-level block diagram of an example, non-limiting system 300 including a set of transactional browsing histories that can facilitate automatically coordinated social buying via monitorial browser extensions in accordance with one or more embodiments described herein. As shown, the system 300 can, in some cases, comprise the same components as the system 200, and can further comprise a set of transactional browsing histories 302.

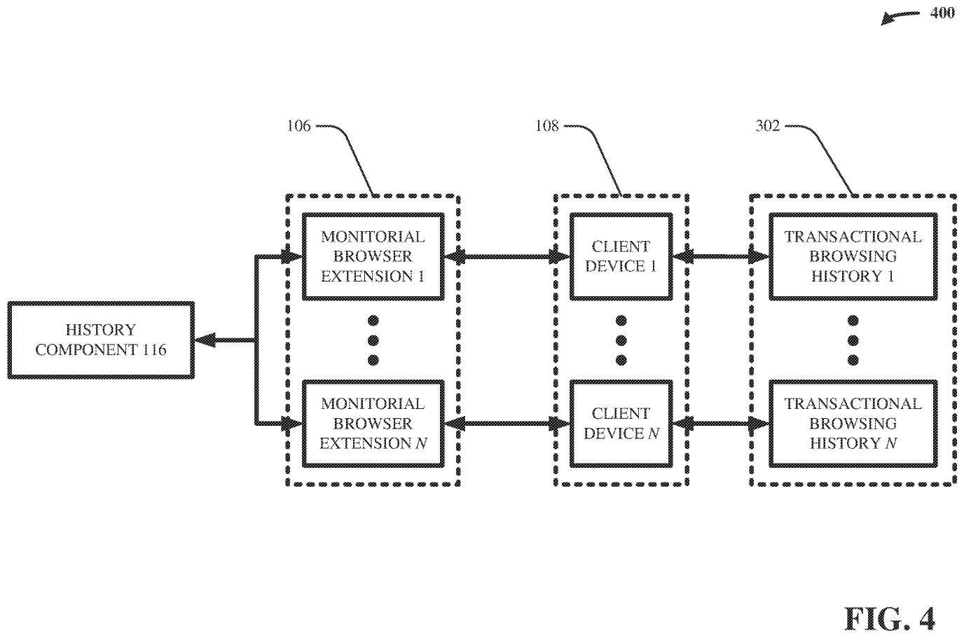

In various embodiments, the history component 116 can electronically receive, retrieve, and/or otherwise access the set of transactional browsing histories 302 from the set of monitorial browser extensions 106. As explained herein, each of the set of monitorial browser extensions 106 can be electronically installed on a web browser of a respectively corresponding one of the set of client devices 108. This means that, in various cases, each of the set of monitorial browser extensions 106 can monitor, log, document, note, record, track, and/or otherwise capture the transactional browsing history (e.g., online transactional browsing activity, online transactional browsing behavior, online shopping activity/behavior) of a respectively corresponding one of the set of client devices 108. Accordingly, in the aggregate, the set of monitorial browser extensions 106 can collectively generate the set of transactional browsing histories 302 by collectively tracking the transactional browsing activity/behavior of the set of client devices 108. This is shown more clearly with respect to FIG. 4.

FIG. 4 illustrates an example, non-limiting block diagram 400 that shows how the set of monitorial browser extensions 106 can collectively record the respectively corresponding set of transactional browsing histories 302 in accordance with one or more embodiments described herein.

In various aspects, the history component 116 can be electronically integrated and/or otherwise in electronic communication, via any suitable wired and/or wireless electronic connection, with the set of monitorial browser extensions 106. In various instances, as shown, the set of monitorial browser extensions 106 can comprise n monitorial browser extensions, for any suitable positive integer n: a monitorial browser extension 1 to a monitorial browser extension n.

In various cases, the set of client devices 108 can respectively correspond to the set of monitorial browser extensions 106. More specifically, the set of client devices 108 can comprise n client devices: a client device 1 to a client device n. In various aspects, as shown, the client device 1 can correspond to the monitorial browser extension 1. In other words, the monitorial browser extension 1 can be electronically installed on the client device 1 (e.g., on a web browser of the client device 1). Similarly, as shown, the client device n can correspond to the monitorial browser extension n. That is, the monitorial browser extension n can be electronically installed on the client device n (e.g., on a web browser of the client device n).

In various aspects, the set of transactional browsing histories 302 can respectively correspond to the set of client devices 108 and/or to the set of monitorial browser extensions 106. More specifically, the set of transactional browsing histories 302 can comprise n transactional browsing histories: a transactional browsing history 1 to a transactional browsing history n. In various instances, as shown, the transactional browsing history 1 can correspond to the client device 1 and/or to the monitorial browser extension 1. In other words, the transactional browsing history 1 can be one or more scalars, vectors, matrices, tensors, and/or character strings that represent the online/web transactional browsing activity/behavior of the client device 1. Since the monitorial browser extension 1 can be installed on the client device 1, the monitorial browser extension 1 can electronically record, track, and/or otherwise capture the transactional browsing history 1. Likewise, as shown, the transactional browsing history n can correspond to the client device n and/or to the monitorial browser extension n. That is, the transactional browsing history n can be one or more scalars, vectors, matrices, tensors, and/or character strings that represent the online/web transactional browsing activity/behavior of the client device n. Because the monitorial browser extension n can be installed on the client device n, the monitorial browser extension n can electronically record, track, and/or otherwise capture the transactional browsing history n. In this way, the set of monitorial browser extensions 106 can collectively capture the set of transactional browsing histories 302, and the history component 116 can electronically obtain and/or otherwise access the set of transactional browsing histories 302 from the set of monitorial browser extensions 106.

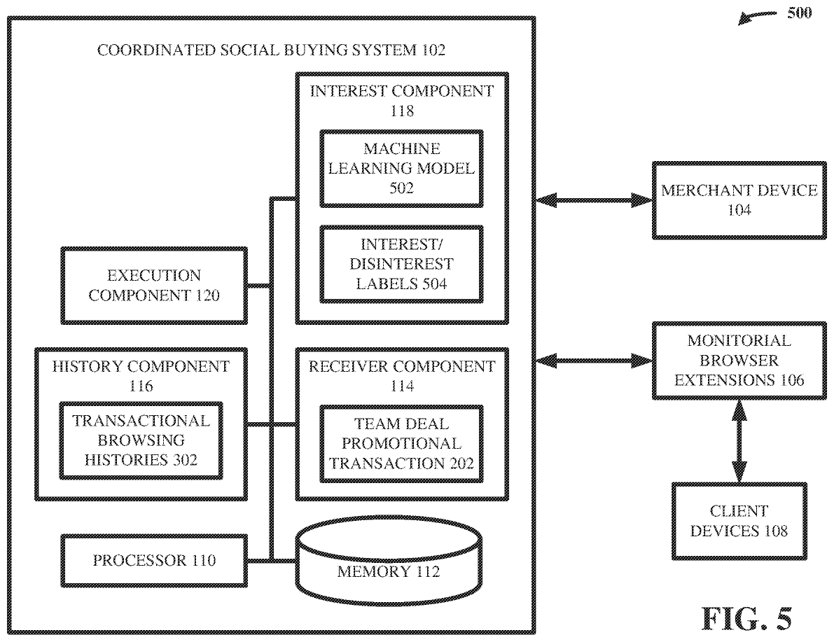

FIG. 5 illustrates a high-level block diagram of an example, non-limiting system 500 including an interest-detection machine learning model that can facilitate automatically coordinated social buying via monitorial browser extensions in accordance with one or more embodiments described herein. As shown, the system 500 can, in some cases, comprise the same components as the system 300, and can further comprise a machine learning model 502 and/or a set of interest/disinterest labels 504.

In various embodiments, the interest component 118 can electronically store, electronically maintain, electronically operate, electronically control, and/or otherwise electronically access the machine learning model 502. In various aspects, the machine learning model 502 can exhibit any suitable artificial intelligence architecture, as desired. As a non-limiting example, the machine learning model 502 can exhibit a deep learning neural network architecture. That is, the machine learning model 502 can comprise any suitable number of neural network layers, any suitable numbers of neurons in various neural network layers, any suitable activation functions in various neurons, and/or any suitable interneuron connectivity patterns. As another non-limiting example, the machine learning model 502 can exhibit a support vector machine architecture, a logistic regression architecture, and/or a naive Bayes architecture.

In any case, the machine learning model 502 can be configured so as to receive as input the electronic data defining the team deal promotional transaction 202 and to also receive as input a transactional browsing history from the set of transactional browsing histories 302, and the machine learning model 502 can be further configured to produce as output a classification that indicates whether the inputted transactional browsing history demonstrates interest (e.g., any suitable threshold level and/or likelihood of interest) in the team deal promotional transaction 202. For example, in cases where the machine learning model 502 exhibits a deep learning neural network architecture, an input layer of the machine learning model 502 can receive as input one or more scalars, vectors, matrices, tensors, and/or character strings that represent the team deal promotional transaction 202 and can also receive as input one or more scalars, vectors, matrices, tensors, and/or character strings that represent a given transactional browsing history from the set of transactional browsing histories 302. In various instances, these inputted scalars, vectors, matrices, tensors, and/or character strings can be fed forward through one or more hidden layers of the machine learning model 502. Based on activation maps generated by the one or more hidden layers, an output layer of the machine learning model 502 can compute a scalar the magnitude of which can indicate a level of interest and/or likelihood of being interested in the team deal promotional transaction 202 that is exhibited, demonstrated, and/or otherwise suggested by the given transactional browsing history. For instance, the scalar that is outputted by the output layer of the machine learning model 502 can range in magnitude from 0 to 1, with values closer to 1 representing high levels and/or likelihoods of interest, and with values closer to 0 representing low levels and/or likelihoods of interest.

As those having ordinary skill in the art will appreciate, the machine learning model 502 can, in various aspects, be trained in a supervised fashion to facilitate accurate interest/disinterest classification of transactional browsing histories. For instance, a training dataset can comprise any suitable number of tuples, with each tuple including one or more scalars, vectors, matrices, tensors, and/or character strings that represent a particular team deal promotional transaction, and with each tuple also including one or more scalars, vectors, matrices, tensors, and/or character strings that represent a particular transactional browsing history. Furthermore, each tuple can be annotated with a corresponding ground-truth label that indicates whether the transactional browsing history that is represented by the tuple demonstrates interest in the team deal promotional transaction that is also represented by the tuple. In various aspects, the internal parameters of the machine learning model 502 can be initialized in any suitable fashion (e.g., random initialization). In various instances, for each tuple in the training dataset, the machine learning model 502 can be fed the tuple, which can cause the machine learning model 502 to output an estimated classification that indicates whether the machine learning model 502 infers that the transactional browsing history that is represented by the tuple demonstrates interest in the team deal promotional transaction that is represented by the tuple. In various cases, an error/loss can be calculated between the estimated classification and the ground-truth label that corresponds to the tuple, and the internal parameters of the machine learning model 502 can be iteratively updated via backpropagation based on the error/loss. This can be repeated for each tuple in the training dataset, thereby causing the internal parameters of the machine learning model 502 to become optimized for accurately classifying whether inputted transactional browsing histories are interested/disinterested in inputted team deal promotional transactions. Those having ordinary skill in the art will understand that any suitable batch sizes, any suitable number of training epochs, any suitable training termination criteria, and/or any suitable error/loss functions can be implemented, as desired.

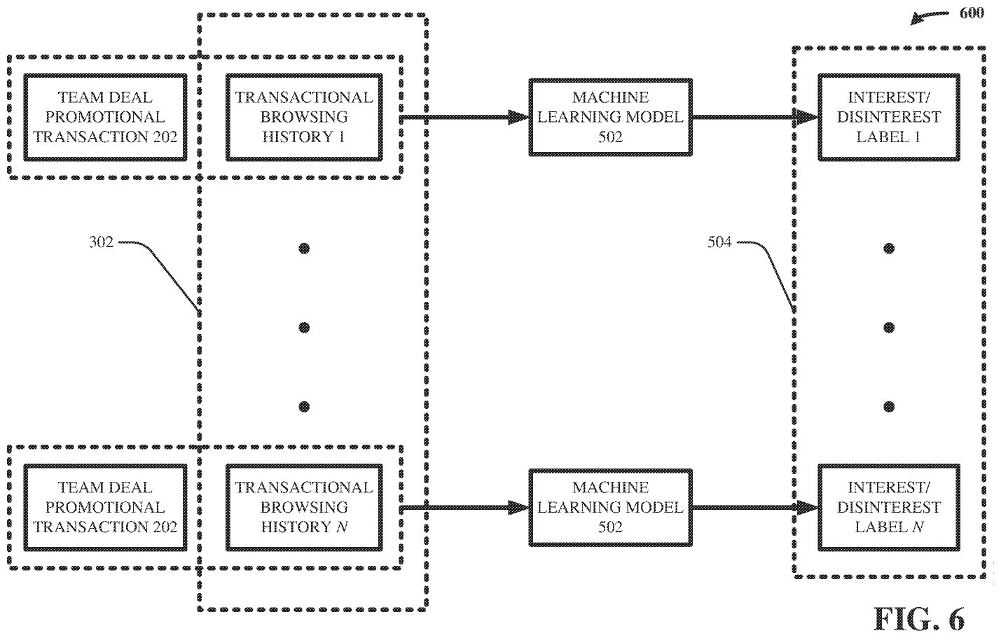

In various aspects, after the machine learning model 502 has been trained, the interest component 118 can electronically execute the machine learning model 502 on each of the set of transactional browsing histories 302, thereby yielding the set of interest/disinterest labels 504. This is shown more clearly with respect to FIG. 6.

FIG. 6 illustrates an example, non-limiting block diagram 600 that shows how the machine learning model 502 can generate the set of interest/disinterest labels 504 based on the respectively corresponding set of transactional browsing histories 302 in accordance with one or more embodiments described herein.

As mentioned above, the set of transactional browsing histories 302 can include n transactional browsing histories: the transactional browsing history 1 to the transactional browsing history n. In various aspects, as shown, the machine learning model 502 can receive as input both the electronic data defining the team deal promotional transaction 202 and the transactional browsing history 1. In other words, the machine learning model 502 can receive as input one or more scalars, vectors, matrices, tensors, and/or character strings that represent the team deal promotional transaction 202 and can also receive one or more scalars, vectors, matrices, tensors, and/or character strings that represent the transactional browsing history 1. Based on such input, the machine learning model 502 can produce as output an interest/disinterest label 1 that indicates whether the transactional browsing history 1 suggests and/or exhibits interest in the team deal promotional transaction 202. For example, the interest/disinterest label 1 can be a scalar having a magnitude between 0 and 1, inclusively. If the magnitude is above any suitable threshold value, this can be interpreted to mean that the transactional browsing history 1 demonstrates sufficient interest in the team deal promotional transaction 1. In contrast, if the magnitude is below any suitable threshold value, this can be interpreted to mean that the transactional browsing history 1 fails to demonstrate sufficient interest in the team deal promotional transaction 1.

Similarly, as shown, the machine learning model 502 can receive as input both the electronic data defining the team deal promotional transaction 202 and the transactional browsing history n. In other words, the machine learning model 502 can receive as input one or more scalars, vectors, matrices, tensors, and/or character strings that represent the team deal promotional transaction 202 and can also receive one or more scalars, vectors, matrices, tensors, and/or character strings that represent the transactional browsing history n. Based on such input, the machine learning model 502 can produce as output an interest/disinterest label n that indicates whether the transactional browsing history n suggests and/or exhibits interest in the team deal promotional transaction 202. For example, the interest/disinterest label n can be a scalar having a magnitude between 0 and 1, inclusively. If the magnitude is above any suitable threshold value, this can be interpreted to mean that the transactional browsing history n demonstrates sufficient interest in the team deal promotional transaction n. In contrast, if the magnitude is below any suitable threshold value, this can be interpreted to mean that the transactional browsing history n fails to demonstrate sufficient interest in the team deal promotional transaction n.

In various aspects, the interest/disinterest label 1 to the interest/disinterest label n can collectively be considered as the set of interest/disinterest labels 504.

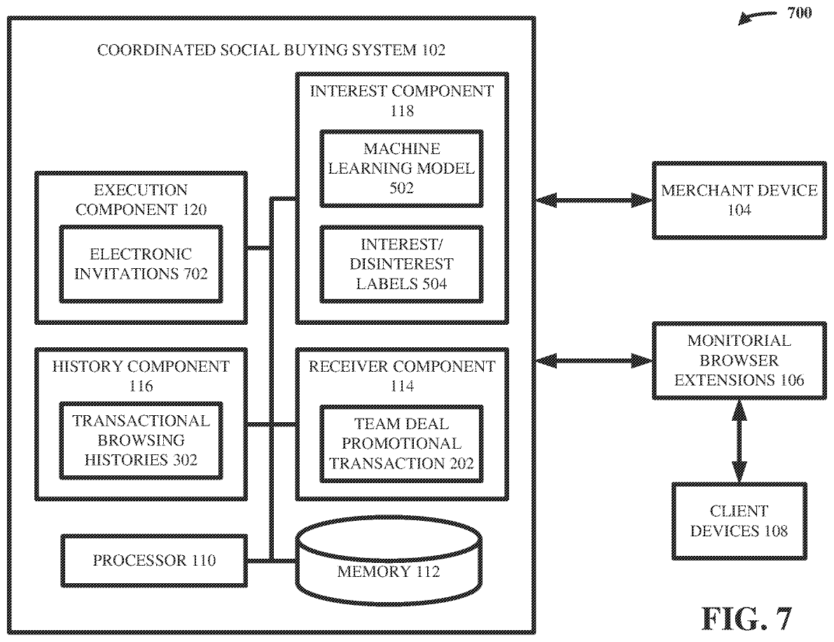

FIG. 7 illustrates a high-level block diagram of an example, non-limiting system 700 including a set of electronic invitations that can facilitate automatically coordinated social buying via monitorial browser extensions in accordance with one or more embodiments described herein. As shown, the system 700 can, in some cases, comprise the same components as the system 500, and can further comprise a set of electronic invitations 702.

In various embodiments, the execution component 120 can electronically generate the set of electronic invitations 702, based on the set of interest/disinterest labels 504. More specifically, the execution component 120 can iterate through each of the set of transactional browsing histories 302. For each transactional browsing history, the execution component 120 can identify, in the set of interest/disinterest labels 504, the interest/disinterest label that corresponds to the transactional browsing history currently under consideration. If the identified interest/disinterest label indicates that the transactional browsing history currently under consideration fails to demonstrate sufficient interest in the team deal promotional transaction 202, the execution component 120 can consider the next transactional browsing history in the set of transactional browsing histories 302. In contrast, if the identified interest/disinterest label indicates that the transactional browsing history currently under consideration demonstrates sufficient interest in the team deal promotional transaction 202, the execution component 120 can electronically transmit an electronic invitation to one of the set of client devices 108 that corresponds to (e.g., that generated) the transactional browsing history currently under consideration. In various cases, the execution component 120 can then consider the next transactional browsing history. As those having ordinary skill in the art will appreciate, all of the electronic invitations that are transmitted by the execution component 120 to transactional browsing histories that demonstrate sufficient interest in the team deal promotional transaction 202 can be collectively considered as the set of electronic invitations 702.

As mentioned above, the set of transactional browsing histories 302 can include n transactional browsing histories. Accordingly, in various cases, the set of electronic invitations 702 can include m electronic invitations, where m is any suitable positive integer that is less than or equal to n, and where m represents the number of transactional browsing histories that show interest in the team deal promotional transaction 202 (e.g., as determined by the machine learning model 502).

In various aspects, when the execution component 120 electronically transmits an electronic invitation (e.g., one of 702) to a client device (e.g., one of 108), the electronic invitation can include text that invites a user (e.g., customer) that owns/operates the client device to participate in the team deal promotional transaction 202. In various instances, the electronic invitation can include any other suitable information, as desired. For example, in some cases, the electronic invitation can specify various details regarding the team deal promotional transaction 202, such as what product/service is involved in the team deal promotional transaction 202, what discounted price is offered in the team deal promotional transaction 202, how many customers are required to activate the team deal promotional transaction 202, a time period and/or expiration date associated with the team deal promotional transaction 202, and/or instructions regarding how to pledge participation in the team deal promotional transaction 202.

In some instances, an electronic invitation that is transmitted to a client device can specify an amount of reward points that a user of the client device can claim by pledging participation in the team deal promotional transaction 202. More specifically, in various cases, when the execution component 120 identifies a transactional browsing history that has been determined to demonstrate sufficient interest in the team deal promotional transaction 202, the execution component 120 can compute and/or calculate an amount of reward points (e.g., Honey® Gold) to offer to a user of the client device as an incentive to participate in the team deal promotional transaction 202. In various aspects, the execution component 120 can compute and/or calculate such amount of reward points by analyzing the identified transactional browsing history via any suitable computational algorithm and/or artificial intelligence technique. In various cases, the amount of reward points can be inversely proportional to the level of interest exhibited by the identified transactional browsing history. For example, if the identified transactional browsing history has an interest/disinterest label that is at and/or near its maximum possible value, this can indicate a high level/likelihood of interest in the team deal promotional transaction 202. Thus, the amount of reward points can be relatively small since a customer that is already highly interested in the team deal promotional transaction 202 does not require large external incentive to participate in the team deal promotional transaction 202. On the other hand, if the identified transactional browsing history has an interest/disinterest label that is at and/or near the threshold value that defines sufficient interest, this can indicate a level/likelihood of interest in the team deal promotional transaction 202 that is sufficient but only just barely so. Thus, the amount of reward points can be relatively large since a customer that is only somewhat interested in the team deal promotional transaction 202 may require large external incentive to participate in the team deal promotional transaction 202.

In some aspects, an electronic invitation that is transmitted to a client device can suggest that a user of the client device share the electronic invitation with one or more other people, such as friends or family. Indeed, in various instances, when the execution component 120 identifies a transactional browsing history that has been generated by a client device and that has been determined to demonstrate sufficient interest in the team deal promotional transaction 202, the execution component 120 can scan the transactional browsing history for one or more other computing devices which have electronically communicated with the client device, and the electronic invitation can suggest that the user of the client device share the electronic invitation with such one or more other computing devices. For example, the execution component 120 can utilize any suitable computational algorithms and/or artificial intelligence techniques to identify, within the transactional browsing history, one or more other computing devices with which the client device has engaged in email correspondence, with which the client device has engaged in instant messaging correspondence, with which the client device has engaged in social media correspondence, and/or with which the client device has engaged in any other suitable type of electronic correspondence. Accordingly, the electronic invitation that is transmitted to the client device can suggest that the electronic invitation be shared with such one or more other computing devices. Indeed, in some cases, the execution component 120 can electronically transmit the electronic invitation to such one or more other computing devices.

In some aspects, an electronic invitation that is transmitted to a client device can include a shareable hyperlink which is configured to prompt installation of a monitorial browser extension. More specifically, the shareable hyperlink can be invocable and/or clickable. In various cases, upon invocation and/or clicking by a computing device, the hyperlink can cause the execution component 120 to determine whether the computing device already has a monitorial browser extension installed. If the computing device that clicks the shareable hyperlink does not already have the shareable hyperlink installed, the execution component 120 can electronically download and install (and/or request permission to download and install) a monitorial browser extension on the computing device. Accordingly, if the electronic invitation is shared with a computing device that does not have a monitorial browser extension, a new monitorial browser extension can be installed on the computing device, thereby increasing the size of the set of monitorial browser extensions 106.

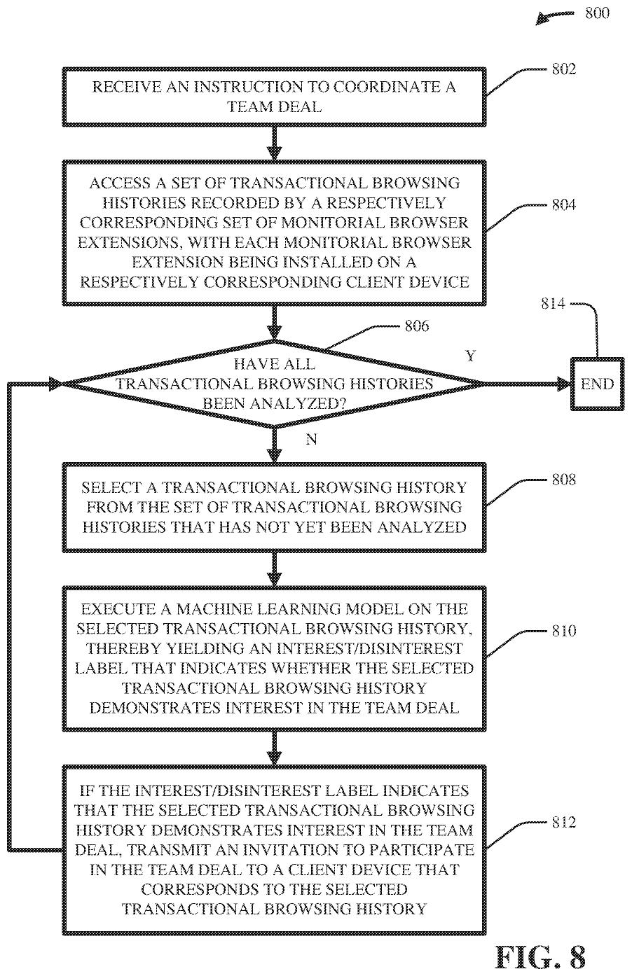

FIG. 8 illustrates a high-level flow diagram of an example, non-limiting computer-implemented method 800 that can identify and invite interested candidates to participate in a team deal in accordance with one or more embodiments described herein. In various cases, the computer-implemented method 800 can be facilitated by the coordinated social buying system 102.

In various embodiments, act 802 can include receiving, by a device (e.g., 114) operatively coupled to a processor, an instruction to coordinate a team deal (e.g., 202).

In various aspects, act 804 can include accessing, by the device (e.g., 116), a set of transactional browsing histories (e.g., 302) recorded by a respectively corresponding set of monitorial browser extensions (e.g., 106). In various cases, each monitorial browser extension can be installed on a respectively corresponding client device (e.g., one of 108).

In various instances, act 806 can include determining, by the device (e.g., 118), whether all transactional browsing histories in the set have been analyzed by the device. If so, the computer-implemented method 800 can proceed to act 814, where the computer-implemented method 800 can end. If not, the computer-implemented method 800 can proceed to act 808.

In various aspects, act 808 can include selecting, by the device (e.g., 118), a transactional browsing history (e.g., one of 302) from the set of transactional browsing histories that has not yet been analyzed by the device.

In various instances, act 810 can include executing, by the device (e.g., 118), a machine learning model (e.g., 502) on the selected transactional browsing history, thereby yielding an interest/disinterest label (e.g., one of 504) that indicates whether the selected transactional browsing history demonstrates interest in the team deal.

In various aspects, act 812 can include, if the interest/disinterest label indicates that the selected transactional browsing history demonstrates interest in the team deal, transmitting, by the device (e.g., 120), an invitation (e.g., one of 702) to participate in the team deal to a client device (e.g., one of 108) that corresponds to the selected transactional browsing history. In various cases, the computer-implemented method 800 can proceed back to act 806.

Although various embodiments described above include electronic transmission of the set of electronic invitations 702 as a mechanism by which to invite clients to participate in the team deal promotional transaction 202, this is a mere non-limiting example. In various embodiments, clients that correspond to transactional browsing histories that indicate/demonstrate interest in the team deal promotional transaction 202 can be notified and/or invited in any other suitable fashion. For example, in some cases, rather than transmitting an electronic invitation to the client device of an interested client, the execution component 120 can electronically highlight an image of a product/service that is involved in the team deal promotional transaction 202 and/or a hyperlink that is associated with the product/service that is involved in the deal promotional transaction 202. In various aspects, such highlighted image and/or hyperlink can be presented on any suitable webpage (e.g., a checkout webpage) and/or on an electronic pop-up window associated with a monitorial browser extension that is installed on the client device. In any case, when the client is browsing the webpage and/or when the electronic pop-up window is presented, the client can visually see the highlighted image and/or hyperlink, and the client can accordingly click on the highlighted image and/or hyperlink to facilitate joining the team deal promotional transaction 202. In various cases, the client can then invite others (e.g., friends, family) to participate in the team deal promotional transaction 202.

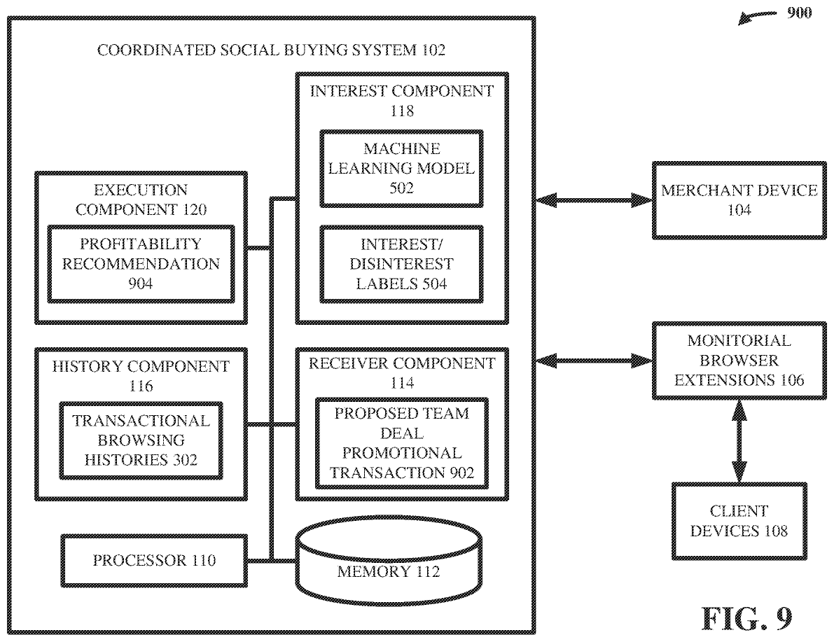

FIG. 9 illustrates a high-level block diagram of an example, non-limiting system 900 including a proposed team deal promotional transaction and a profitability recommendation that can facilitate automatically coordinated social buying via monitorial browser extensions in accordance with one or more embodiments described herein. As shown, the system 900 can, in some cases, comprise the same components as the system 700, and can further comprise electronic data defining a proposed team deal promotional transaction 902 and/or a profitability recommendation 904.

In various embodiments, it can sometimes be the case that the merchant that owns/operates the merchant device 104 is not currently offering the team deal promotional transaction 202. Instead, it can be the case the merchant that owns/operates the merchant device 104 is deciding whether or not to offer a team deal promotional transaction at all. In such cases, the receiver component 114 can electronically receive, retrieve, and/or otherwise access, from the merchant device 104, electronic data defining the proposed team deal promotional transaction 902.

In various instances, the proposed team deal promotional transaction 902 can be a team deal that is not yet officially offered by the merchant. In various cases, the electronic data can specify, indicate, and/or otherwise represent any suitable details regarding the proposed team deal promotional transaction 902. For example, the electronic data can specify a product and/or service that would be the subject of the proposed team deal promotional transaction 902. As another example, the electronic data can specify a per-unit cost that the merchant incurs for such product/service. As yet another example, the electronic data can specify a discounted per-unit price at which the merchant would offer and/or is contemplating offering such product/service. As still another example, the electronic data can specify a minimum number of customers that would have to participate in the proposed team deal promotional transaction 902 in order for the discounted per-unit price to be applied. As another example, the electronic data can specify a time period during which the proposed team deal promotional transaction 902 is and/or will be active.

As those having ordinary skill in the art will appreciate, in various aspects, the electronic data defining the proposed team deal promotional transaction 902 can exhibit any suitable format. For example, the electronic data defining the proposed team deal promotional transaction 902 can be configured and/or formatted as one or more scalars, one or more vectors, one or more matrices, one or more tensors, one or more character strings, and/or any suitable combination thereof.

In various aspects, the history component 116 can access the set of transactional browsing histories 302 as described above, and the interest component 118 can execute the machine learning model 502 on each of the set of transactional browsing histories as well as the electronic data defining the proposed team deal promotional transaction 902. The result can be the set of interest/disinterest labels 504, where each interest/disinterest label indicates whether a corresponding transactional browsing history demonstrates interest or disinterest in the proposed team deal promotional transaction 902. In various cases, the execution component 120 can electronically count how many of the set of interest/disinterest labels 504 indicate interest in the proposed team deal promotional transaction 902. If the number of interest/disinterest labels that indicate interest in the proposed team deal promotional transaction 902 is greater than any suitable threshold number, the execution component 120 can conclude that the proposed team deal promotional transaction 902 would be sufficiently profitable. On the other hand, if the number of interest/disinterest labels that indicate interest in the proposed team deal promotional transaction 902 is lesser than the threshold number, the execution component 120 can conclude that the proposed team deal promotional transaction 902 would not be sufficiently profitable.

Those having ordinary skill in the art will appreciate that the threshold number can be computed in any suitable fashion. For example, the threshold number can be equal to and/or otherwise based on the number of customers that would be needed to participate in the proposed team deal promotional transaction so that the merchant breaks even, earns a minimum amount of profit, and/or otherwise earns a desired level of return, when given a specified price discount and/or a specified profit margin that would be involved in the proposed team deal promotional transaction 902. As those having ordinary skill in the art will appreciate, the profitability recommendation 904 can, in some cases, be considered as indicating whether or not a specified return-on-advertising-spend (ROAS) would be achieved by the proposed team deal promotional transaction 902.

In any case, the execution component 120 can electronically transmit the profitability recommendation 904 to the merchant device 104, where the profitability recommendation 904 indicates and/or specifies the conclusion of the execution component 120 (e.g., indicates and/or specifies whether the proposed team deal promotional transaction 902 would be profitable or not).

In some aspects, if the execution component 120 concludes that the proposed team deal promotional transaction 902 would not be profitable and/or would not be sufficiently profitable, this can indicate that too few transactional browsing histories (meaning too few customers) demonstrate interest in the proposed team deal promotional transaction 902, relative to the discounted per-unit price that would be implemented in the proposed team deal promotional transaction 902. Thus, in some cases, the execution component 120 can leverage the number of interest/disinterest labels that indicate interest in the proposed team deal promotional transaction 902 to compute a new discounted per-unit price, where the new discounted price would allow the proposed team deal promotional transaction 902 to be profitable and/or sufficiently profitable. For example, if the merchant desires to make a desired amount of profit, and if the number of interested transactional browsing histories (e.g., representing the number of interested customers) is known, then a new and/or updated per-unit profit (e.g., new profit margin and/or new discounted per-unit price) can be computed based on dividing the desired amount of profit by the number of interested transactional browsing histories. In various cases, the profitability recommendation 904 can indicate and/or specify such new discounted per-unit price.

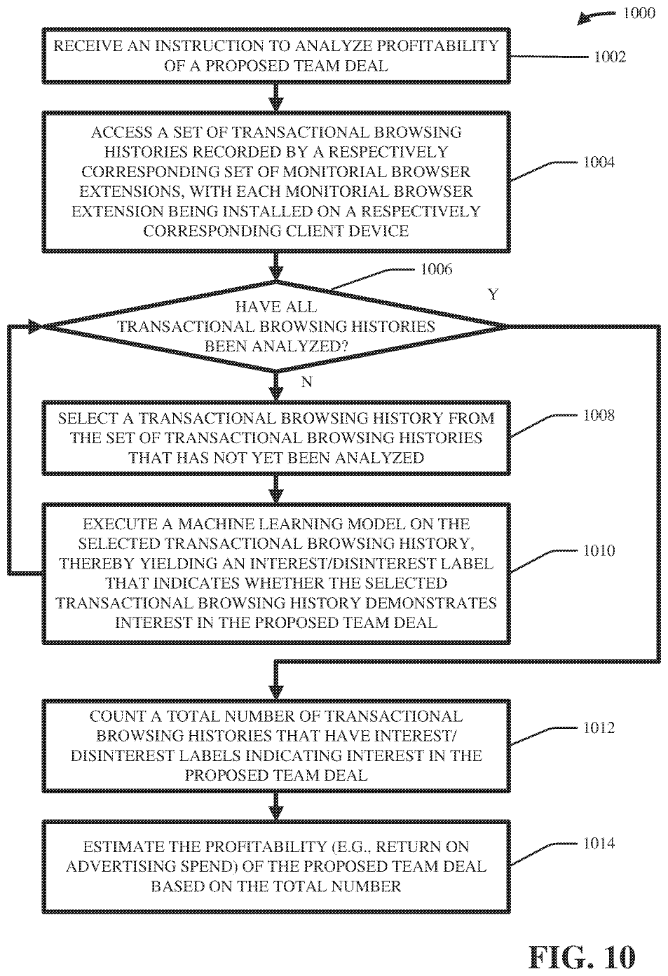

FIG. 10 illustrates a high-level flow diagram of an example, non-limiting computer-implemented method 1000 that can estimate profitability of a proposed team deal based on how many candidates are likely interested in the proposed team deal in accordance with one or more embodiments described herein. In various cases, the computer-implemented method 1000 can be facilitated by the coordinated social buying system 102.

In various embodiments, act 1002 can include receiving, by a device (e.g., 114) operatively coupled to a processor, an instruction to analyze profitability of a proposed team deal (e.g., 902).

In various aspects, act 1004 can include accessing, by the device (e.g., 116), a set of transactional browsing histories (e.g., 302) recorded by a respectively corresponding set of monitorial browser extensions (e.g., 106). In various cases, each monitorial browser extension can be installed on a respectively corresponding client device (e.g., one of 108).

In various instances, act 1006 can include determining, by the device (e.g., 118), whether all transactional browsing histories in the set have been analyzed by the device. If so, the computer-implemented method 1000 can proceed to act 1012. If not, the computer-implemented method 1000 can proceed to act 1008.

In various aspects, act 1008 can include selecting, by the device (e.g., 118), a transactional browsing history (e.g., one of 302) from the set of transactional browsing histories that has not yet been analyzed by the device.

In various instances, act 1010 can include executing, by the device (e.g., 118), a machine learning model (e.g., 502) on the selected transactional browsing history, thereby yielding an interest/disinterest label that indicates whether the selected transactional browsing history demonstrates interest in the proposed team deal. In various cases, the computer-implemented method 1000 can proceed back to act 1006.

In various aspects, act 1012 can include counting, by the device (e.g., 120), a total number of transactional browsing histories that have interest/disinterest labels indicating interest in the proposed team deal.

In various instances, act 1014 can include estimating, by the device (e.g., 120), the profitability (e.g., sufficiently profitable versus not sufficiently profitable; whether or not a specified return-on-advertising-spend would be achieved) of the proposed team deal based on the total number of transactional browsing histories that have interest/disinterest labels indicating interest in the proposed team deal.

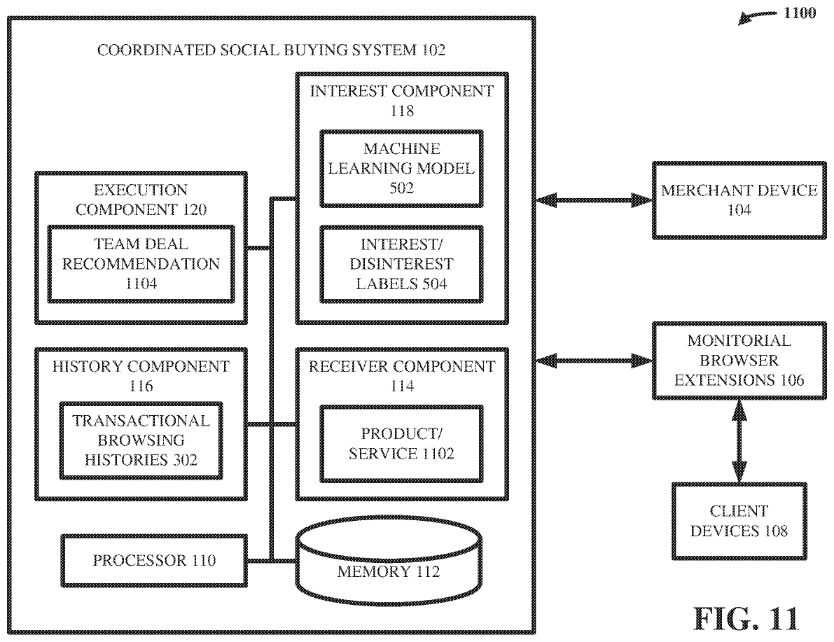

FIG. 11 illustrates a high-level block diagram of an example, non-limiting system 1100 including a product/service and a team deal recommendation that can facilitate automatically coordinated social buying via monitorial browser extensions in accordance with one or more embodiments described herein. As shown, the system 1100 can, in some cases, comprise the same components as the system 900, and can further comprise electronic data defining a product/service 1102 and/or a team deal recommendation 1104.

In various embodiments, it can sometimes be the case that the merchant that owns/operates the merchant device 104 is not currently offering the team deal promotional transaction 202 and is not currently contemplating whether or not to offer the proposed team deal promotional transaction 902. In such cases, the receiver component 114 can electronically receive, retrieve, and/or otherwise access, from the merchant device 104, electronic data defining the product/service 1102.

In various cases, the product/service 1102 can be a product and/or a service that is currently available in an inventory of the merchant, as indicated by an electronic inventory log accessible by and/or through the merchant device 104. In various cases, the electronic data can specify, indicate, and/or otherwise represent any suitable details regarding the product/service 1102. For example, the electronic data can specify a per-unit cost that the merchant incurs for the product/service 1102. As another example, the electronic data can specify a current per-unit sale price for the product/service 1102. As yet another example, the electronic data can specify a minimum amount of profit that the merchant desires to earn with respect to the product/service 1102.

As those having ordinary skill in the art will appreciate, in various aspects, the electronic data defining the product/service 1102 can exhibit any suitable format. For example, the electronic data defining the product/service 1102 can be configured and/or formatted as one or more scalars, one or more vectors, one or more matrices, one or more tensors, one or more character strings, and/or any suitable combination thereof.

In various aspects, the history component 116 can access the set of transactional browsing histories 302 as described above, and the interest component 118 can execute the machine learning model 502 on each of the set of transactional browsing histories 302 and on the electronic data defining the product/service 1102. The result can be the set of interest/disinterest labels 504, where each interest/disinterest label indicates whether a corresponding transactional browsing history demonstrates interest or disinterest in the product/service 1102. In various cases, the execution component 120 can electronically count how many of the set of interest/disinterest labels 504 indicate interest in the product/service 1102. If the number of interest/disinterest labels that indicate interest in the product/service 1102 is greater than any suitable threshold number, the execution component 120 can conclude that offering a team deal with respect to the product/service 1102 would be sufficiently profitable. On the other hand, if the number of interest/disinterest labels that indicate interest in the product/service 1102 is lesser than the threshold number, the execution component 120 can conclude that offering a team deal with respect to the product/service 1102 would not be sufficiently profitable.

Those having ordinary skill in the art will appreciate that the threshold number can be computed in any suitable fashion, as above. For example, the threshold number can be equal to and/or otherwise based on the total profit (e.g., total return-on-advertising-spend) desired by the merchant with respect to the product/service 1102 divided by the current per-unit sale price of the product/service 1102 (e.g., if the number of customers that purchase the product/service 1102 is equal to or greater than that quotient, then the desired total profit can be attained by way of a team deal promotional transaction at a discounted price). In any case, the execution component 120 can electronically transmit the team deal recommendation 1104 to the merchant device 104, where the team deal recommendation 1104 indicates and/or specifies the conclusion of the execution component 120. In some cases, if the execution component 120 determines that a team deal with respect to the product/service 1102 would be profitable, the execution component 120 can compute a discounted per-unit price at which such a team deal might offer the product/service 1102 (e.g., can be equal to and/or based on desired total profit divided by the number of interested transactional browsing histories). In such case, the team deal recommendation 1104 can specify and/or indicate such discounted per-unit price.

In various embodiments, as mentioned above, if the execution component 120 determines that a team deal promotional transaction with respect to the product/service 1102 would be sufficiently profitable, the execution component 120 can visually highlight an image and/or hyperlink that is associated with the product/service 1102 (e.g., can highlight the image/hyperlink as displayed in a checkout webpage, can highlight the image/hyperlink as displayed in a monitorial browser extension pop-up window), and a client can click on and/or otherwise invoke the highlighted image/hyperlink to participate in the team deal promotional transaction with respect to the product/service 1102. Also, as mentioned above, the client can invite others (e.g., friends, family) to participate in the team deal promotional transaction.

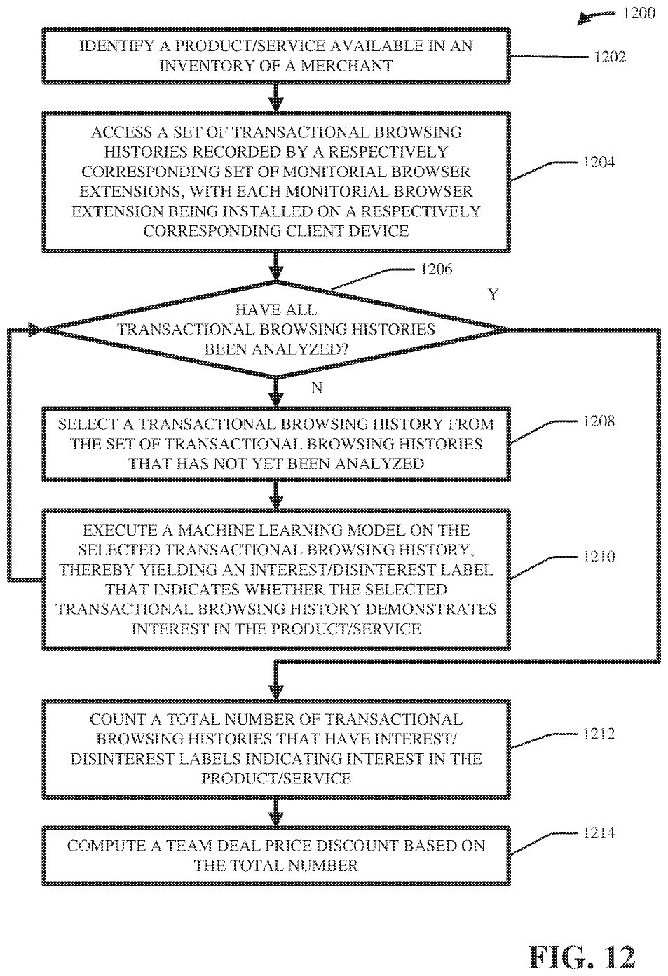

FIG. 12 illustrates a high-level flow diagram of an example, non-limiting computer-implemented method 1200 that can identify an available product/service and recommend whether a team deal regarding the available product/service would be profitable based on how many candidates are likely interested in the available product/service in accordance with one or more embodiments described herein. In various cases, the computer-implemented method 1200 can be facilitated by the coordinated social buying system 102.

In various embodiments, act 1202 can include identifying, by a device (e.g., 114) operatively coupled to a processor, a product/service (e.g., 1102) that is available in an inventory of a merchant.

In various aspects, act 1204 can include accessing, by the device (e.g., 116), a set of transactional browsing histories (e.g., 302) recorded by a respectively corresponding set of monitorial browser extensions (e.g., 106). In various cases, each monitorial browser extension can be installed on a respectively corresponding client device (e.g., one of 108).

In various instances, act 1206 can include determining, by the device (e.g., 118), whether all transactional browsing histories in the set have been analyzed by the device. If so, the computer-implemented method 1200 can proceed to act 1212. If not, the computer-implemented method 1200 can proceed to act 1208.

In various aspects, act 1208 can include selecting, by the device (e.g., 118), a transactional browsing history (e.g., one of 302) from the set of transactional browsing histories that has not yet been analyzed by the device.

In various instances, act 1210 can include executing, by the device (e.g., 118), a machine learning model (e.g., 502) on the selected transactional browsing history, thereby yielding an interest/disinterest label (e.g., one of 504) that indicates whether the selected transactional browsing history demonstrates interest in the product/service. As shown, the computer-implemented method 1200 can, in some cases, proceed back to act 1206.

In various aspects, act 1212 can include counting, by the device (e.g., 120), a total number of transactional browsing histories that have interest/disinterest labels indicating interest in the product/service.

In various instances, act 1214 can include computing, by the device (e.g., 120), a team deal price discount based on the total number of transactional browsing histories that have interest/disinterest labels indicating interest in the product/service.

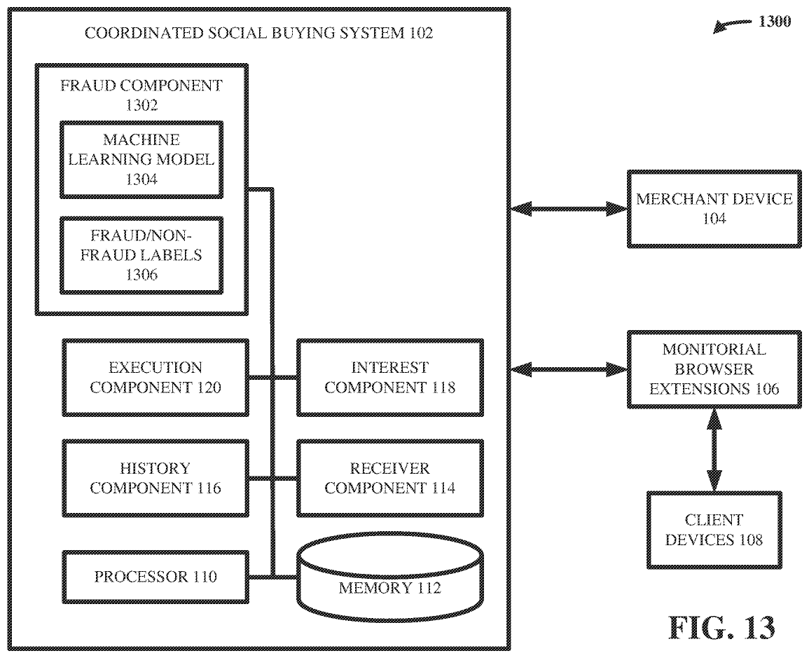

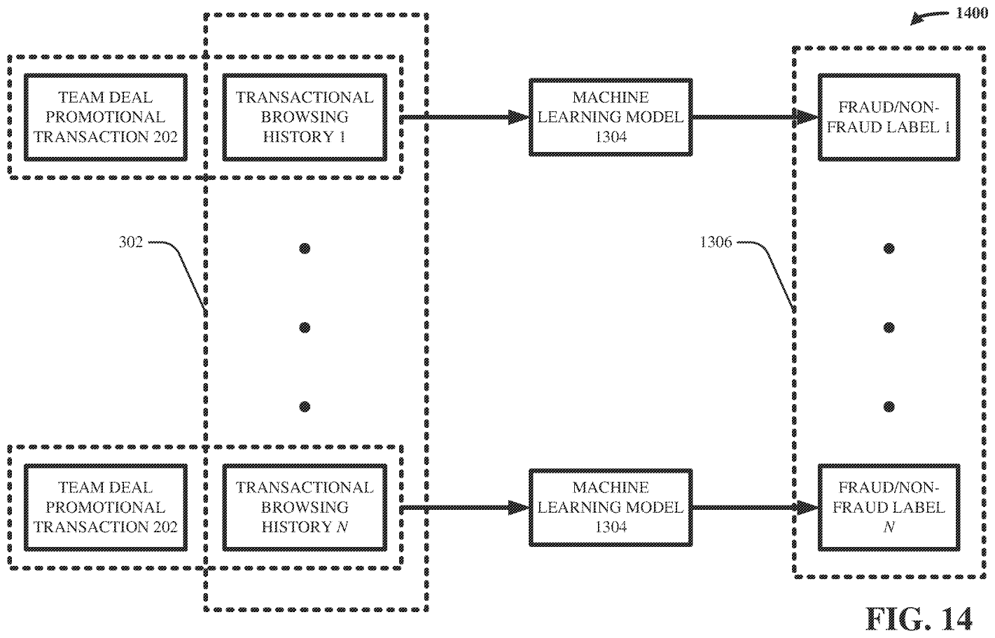

Various of the above-described embodiments mainly pertain to situations in which the execution component 120 transmits electronic invitations (e.g., 702) and/or computes profitability determinations (e.g., 904 and/or 1104) based on the set of interest/disinterest labels 504. In various other cases, however, the execution component 120 can take additional information into account when performing such actions. Specifically, in addition to considering whether a given transactional browsing history demonstrates interest in a team deal (e.g., 202), a proposed team deal (e.g., 902), and/or a product/service (e.g., 1102), the execution component 120 can also take into consideration whether the given transactional browsing history demonstrates a threshold level and/or likelihood of fraud with respect to the team deal, proposed team deal, and/or product/service. This is described in more detail with respect to FIGS. 13-14.

FIG. 13 illustrates a high-level block diagram of an example, non-limiting system 1300 including a fraud-detection machine learning model that can facilitate automatically coordinated social buying via monitorial browser extensions in accordance with one or more embodiments described herein. As shown, the system 1300 can, in some cases comprise the same components as the system 1100, and can further comprise a fraud component 1302.

In various embodiments, the fraud component 1302 can electronically store, electronically maintain, electronically operate, electronically control, and/or otherwise electronically access a machine learning model 1304. In various aspects, the machine learning model 1304 can exhibit any suitable artificial intelligence architecture, as desired. As a non-limiting example, the machine learning model 1304 can exhibit a deep learning neural network architecture. That is, the machine learning model 1304 can comprise any suitable number of neural network layers, any suitable numbers of neurons in various neural network layers, any suitable activation functions in various neurons, and/or any suitable interneuron connectivity patterns. As another non-limiting example, the machine learning model 1304 can exhibit a support vector machine architecture, a logistic regression architecture, and/or a naive Bayes architecture.

In any case, the machine learning model 304 can be configured so as to receive as input the electronic data defining the team deal promotional transaction 202 (and/or defining the proposed team deal promotional transaction 902 and/or the product/service 1102, as the case may be) and to also receive as input a transactional browsing history from the set of transactional browsing histories 302, and the machine learning model 1304 can be further configured to produce as output a classification that indicates whether the inputted transactional browsing history demonstrates a threshold level and/or likelihood of fraudulent behavior with respect to the team deal promotional transaction 202. For example, in cases where the machine learning model 1304 exhibits a deep learning neural network architecture, an input layer of the machine learning model 1304 can receive as input one or more scalars, vectors, matrices, tensors, and/or character strings that represent the team deal promotional transaction 202 and can also receive as input one or more scalars, vectors, matrices, tensors, and/or character strings that represent a given transactional browsing history from the set of transactional browsing histories 302. In various instances, these inputted scalars, vectors, matrices, tensors, and/or character strings can be fed forward through one or more hidden layers of the machine learning model 1304. Based on activation maps generated by the one or more hidden layers, an output layer of the machine learning model 1304 can compute a scalar the magnitude of which can indicate a level of fraudulent behavior and/or likelihood of engaging in and/or attempting to engage in fraudulent behavior with respect to the team deal promotional transaction 202 that is exhibited, demonstrated, and/or otherwise suggested by the given transactional browsing history. For instance, the scalar that is outputted by the output layer of the machine learning model 1304 can range in magnitude from 0 to 1 inclusively, with values closer to 1 representing high levels and/or likelihoods of fraud (e.g., meaning that a customer who generated the inputted transactional browsing history is more likely to engage in suspicious cancellations and/or returns if he/she were to participate in the proposed team deal promotional transaction 902), and with values closer to 0 representing low levels and/or likelihoods of fraud (e.g., meaning that the customer who generated the inputted transactional browsing history is less likely to engage in suspicious cancellations and/or returns if he/she were to participate in the proposed team deal promotional transaction 902).

As those having ordinary skill in the art will appreciate, the machine learning model 1304 can, in various aspects, be trained in a supervised fashion to facilitate accurate fraud/non-fraud classification of transactional browsing histories. For instance, a training dataset can comprise any suitable number of tuples, with each tuple including one or more scalars, vectors, matrices, tensors, and/or character strings that represent a particular team deal promotional transaction, and with each tuple also including one or more scalars, vectors, matrices, tensors, and/or character strings that represent a particular transactional browsing history. Furthermore, each tuple can be annotated with a corresponding ground-truth label that indicates whether the transactional browsing history that is represented by the tuple demonstrates fraudulent behavior with respect to the team deal promotional transaction that is also represented by the tuple. In various aspects, the internal parameters of the machine learning model 1304 can be initialized in any suitable fashion (e.g., random initialization). In various instances, for each tuple in the training dataset, the machine learning model 1304 can be fed the tuple, which can cause the machine learning model 1304 to output an estimated classification that indicates whether the machine learning model 1304 infers that the transactional browsing history that is represented by the tuple demonstrates likely fraud with respect to the team deal promotional transaction that is represented by the tuple. In various cases, an error/loss can be calculated between the estimated classification and the ground-truth label that corresponds to the tuple, and the internal parameters of the machine learning model 1304 can be iteratively updated via backpropagation based on the error/loss. This can be repeated for each tuple in the training dataset, thereby causing the internal parameters of the machine learning model 1304 to become optimized for accurately classifying whether inputted transactional browsing histories suggest likely fraudulent activity with respect to inputted team deal promotional transactions. Those having ordinary skill in the art will understand that any suitable batch sizes, any suitable number of training epochs, any suitable training termination criteria, and/or any suitable error/loss functions can be implemented, as desired.

In various aspects, after the machine learning model 1304 has been trained, the fraud component 1302 can electronically execute the machine learning model 1304 on each of the set of transactional browsing histories 302, thereby yielding a set of fraud/non-fraud labels 1306. This is shown more clearly with respect to FIG. 14.

FIG. 14 illustrates an example, non-limiting block diagram 1400 that shows how the machine learning model 1304 can generate the set of fraud/non-fraud labels 1306 based on the respectively corresponding set of transactional browsing histories 302 in accordance with one or more embodiments described herein.

As mentioned above, the set of transactional browsing histories 302 can include n transactional browsing histories: the transactional browsing history 1 to the transactional browsing history n. In various aspects, as shown, the machine learning model 1304 can receive as input both the electronic data defining the team deal promotional transaction 202 (and/or defining the proposed team deal promotional transaction 902 and/or the product/service 1102, as the case may be) and the transactional browsing history 1. In other words, the machine learning model 1304 can receive as input one or more scalars, vectors, matrices, tensors, and/or character strings that represent the team deal promotional transaction 202 and can also receive one or more scalars, vectors, matrices, tensors, and/or character strings that represent the transactional browsing history 1. Based on such input, the machine learning model 1304 can produce as output a fraud/non-fraud label 1 that indicates whether the transactional browsing history 1 suggests and/or exhibits likely fraudulent activity with respect to the team deal promotional transaction 202 (e.g., many unexplained product/service returns, many unexplained cancellations of product/service orders, and/or any other unusual/suspicious transactional behaviors). For example, the fraud/non-fraud label 1 can be a scalar having a magnitude between 0 and 1, inclusively. If the magnitude is above any suitable threshold value, this can be interpreted to mean that the transactional browsing history 1 demonstrates sufficient signs of fraudulent and/or suspicious activity that is likely to be attempted with respect to the team deal promotional transaction 1. In contrast, if the magnitude is below any suitable threshold value, this can be interpreted to mean that the transactional browsing history 1 fails to demonstrate sufficient signs of fraudulent and/or suspicious activity that is likely to be attempted with respect to the team deal promotional transaction 1.

Similarly, as shown, the machine learning model 1304 can receive as input both the electronic data defining the team deal promotional transaction 202 (and/or the proposed team deal promotional transaction 902 and/or the product/service 1102, as the case may be) and the transactional browsing history n. In other words, the machine learning model 1304 can receive as input one or more scalars, vectors, matrices, tensors, and/or character strings that represent the team deal promotional transaction 202 and can also receive one or more scalars, vectors, matrices, tensors, and/or character strings that represent the transactional browsing history n. Based on such input, the machine learning model 1304 can produce as output a fraud/non-fraud label n that indicates whether the transactional browsing history n suggests and/or exhibits likely fraudulent activity with respect to the team deal promotional transaction 202. For example, the fraud/non-fraud label n can be a scalar having a magnitude between 0 and 1, inclusively. If the magnitude is above any suitable threshold value, this can be interpreted to mean that the transactional browsing history n demonstrates sufficient signs of fraudulent and/or suspicious activity that is likely to be attempted with respect to the team deal promotional transaction n. In contrast, if the magnitude is below any suitable threshold value, this can be interpreted to mean that the transactional browsing history n fails to demonstrate sufficient signs of fraudulent and/or suspicious activity that is likely to be attempted with respect to the team deal promotional transaction n.

In various aspects, the fraud/non-fraud label 1 to the fraud/non-fraud label n can collectively be considered as the set of fraud/non-fraud labels 1306.

In various cases, the execution component 120 can initiate various computerized actions based on both the set of interest/disinterest labels 504 and the set of fraud/non-fraud labels 1306. For example, in cases where the execution component 120 generates the set of electronic invitations 702, the execution component 120 can transmit an electronic invitation to a client device the transactional browsing history of which has both an interest/disinterest label indicating interest in the team deal promotional transaction 202 and a fraud/non-fraud label indicating unlikely fraud with respect to the team deal promotional transaction 202. In other words, the execution component 120 can refrain from transmitting an electronic invitation to a client device that has a transactional browsing history demonstrating disinterest in the team deal promotional transaction 202 and/or a demonstrating likely fraud with respect to the team deal promotional transaction 202.

As another example, in cases where the execution component 120 generates the profitability recommendation 904, the execution component 120 can count each transactional browsing history in the set of transactional browsing histories 302 that has both an interest/disinterest label indicating interest in the proposed team deal promotional transaction 902 and a fraud/non-fraud label indicating unlikely fraud with respect to the proposed team deal promotional transaction 902. That is, the execution component 120 can avoid counting any transactional browsing history that demonstrates disinterest in the proposed team deal promotional transaction 902 and/or that demonstrates likely fraud with respect to the proposed team deal promotional transaction 902.

As still another example, in cases where the execution component 120 generates the team deal recommendation 1104, the execution component 120 can count each transactional browsing history in the set of transactional browsing histories 302 that has both an interest/disinterest label indicating interest in the product/service 1102 and a fraud/non-fraud label indicating unlikely fraud with respect to the product/service 1102. That is, the execution component 120 can avoid counting any transactional browsing history that demonstrates disinterest in the product/service 1102 and/or that demonstrates likely fraud with respect to the product/service 1102.

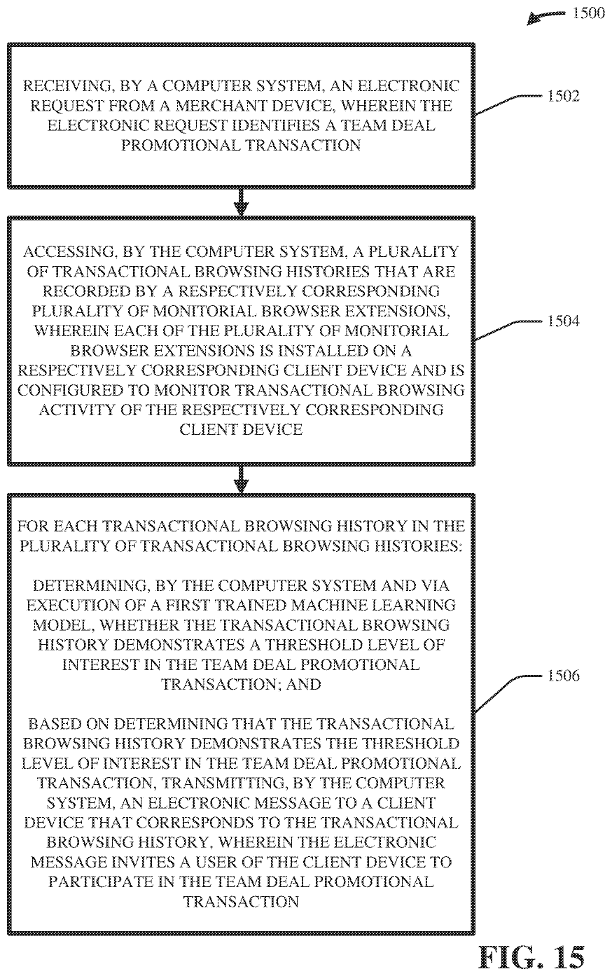

FIGS. 15-17 illustrate high-level flow diagrams of example, non-limiting computer-implemented methods 1500-1700 that can facilitate automatically coordinated social buying via monitorial browser extensions in accordance with one or more embodiments described herein. In various cases, the coordinated social buying system 102 can facilitate the computer-implemented methods 1500-1700.

First, consider FIG. 15. In various embodiments, act 1502 can include receiving, by a computer system (e.g., 114), an electronic request from a merchant device (e.g., 104), wherein the electronic request identifies a team deal promotional transaction (e.g., 202).

In various aspects, act 1504 can include accessing, by the computer system (e.g., 116), a plurality of transactional browsing histories (e.g., 302) that are recorded by a respectively corresponding plurality of monitorial browser extensions (e.g., 106). In various cases, each of the plurality of monitorial browser extensions can be installed on a respectively corresponding client device (e.g., one of 108) and can be configured to monitor transactional browsing activity of the respectively corresponding client device.

In various instances, act 1506 can include, for each transactional browsing history in the plurality of transactional browsing histories (e.g., for each of 302), determining, by the computer system (e.g., 118) and via execution of a first trained machine learning model (e.g., 502), whether the transactional browsing history demonstrates a threshold level of interest in the team deal promotional transaction. In various cases, act 1506 can further include, based on determining that the transactional browsing history demonstrates the threshold level of interest in the team deal promotional transaction, transmitting, by the computer system (e.g., 120), an electronic message (e.g., one of 702) to a client device (e.g., one of 108) that corresponds to the transactional browsing history. In various aspects, the electronic message can invite a user of the client device to participate in the team deal promotional transaction.

Although not explicitly shown in FIG. 15, the computer-implemented method 1500 can further include: estimating, by the computer system (e.g., 120), an amount of reward points based on the transactional browsing history, and the electronic message can indicate that receipt of the amount of reward points is conditioned on participation in the team deal promotional transaction.

Although not explicitly shown in FIG. 15, the electronic message can include a shareable hyperlink. In various cases, invocation (e.g., clicking) of the shareable hyperlink by a computing device can cause the computer system (e.g., 120) to install a monitorial browser extension on the computing device if the monitorial browser extension is not already installed on the computing device.

Although not explicitly shown in FIG. 15, the computer-implemented method 1500 can further include: identifying, by the computer system (e.g., 120), one or more other client devices based on the transactional browsing history, where the one or more other client devices can be different from the client device, and where the electronic message can suggest that the user of the client device share the electronic message with the one or more other client devices.

Although not explicitly shown in FIG. 15, the computer-implemented method 1500 can further include: identifying, by the computer system (e.g., 120), one or more other client devices based on the transactional browsing history, where the one or more other client devices can be different from the client device; and transmitting, by the computer system (e.g., 120), the electronic message to the one or more other client devices.

Although not explicitly shown in FIG. 15, the computer-implemented method 1500 can further include: determining, by the computer system (e.g., 1302) and via execution of a second trained machine learning model (e.g., 1304), whether the transactional browsing history demonstrates a threshold level of fraud. In various cases, the transmitting the electronic message can be based on determining that the transactional browsing history does not demonstrate the threshold level of fraud.

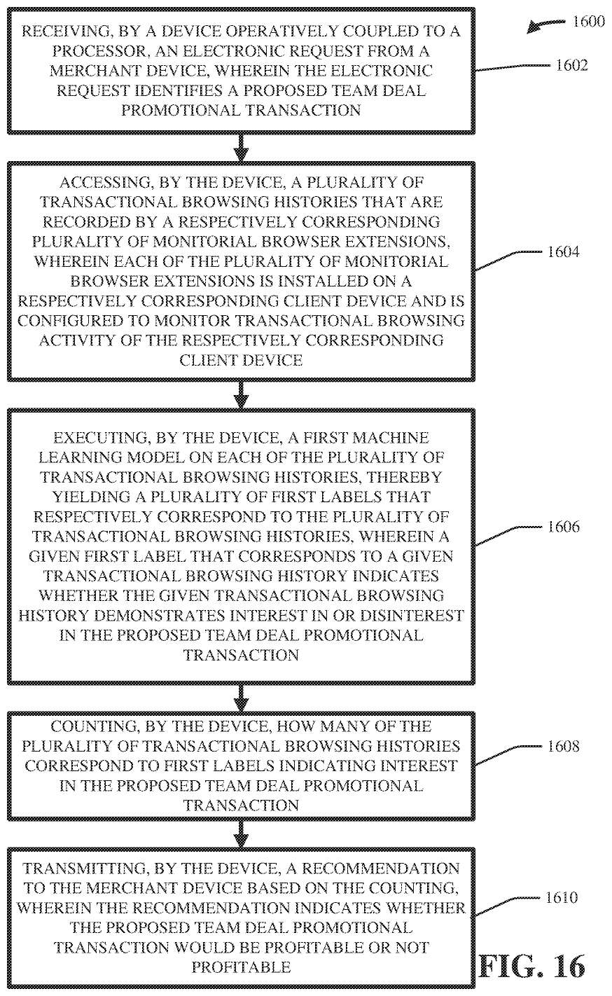

Next, consider FIG. 16. In various embodiments, act 1602 can include receiving, by a device (e.g., 114) operatively coupled to a processor, an electronic request from a merchant device (e.g., 104), wherein the electronic request identifies a proposed team deal promotional transaction (e.g., 902).

In various aspects, act 1604 can include accessing, by the device (e.g., 116), a plurality of transactional browsing histories (e.g., 302) that are recorded by a respectively corresponding plurality of monitorial browser extensions (e.g., 106). In various cases, each of the plurality of monitorial browser extensions can be installed on a respectively corresponding client device (e.g., one of 108) and can be configured to monitor transactional browsing activity of the respectively corresponding client device.

In various instances, act 1606 can include executing, by the device (e.g., 118), a first machine learning model (e.g., 502) on each of the plurality of transactional browsing histories, thereby yielding a plurality of first labels (e.g., 504) that respectively correspond to the plurality of transactional browsing histories. In various cases, a given first label that corresponds to a given transactional browsing history can indicate whether the given transactional browsing history demonstrates interest in or disinterest in the proposed team deal promotional transaction.

In various aspects, act 1608 can include counting, by the device (e.g., 120), how many of the plurality of transactional browsing histories correspond to first labels indicating interest in the proposed team deal promotional transaction.

In various instances, act 1610 can include transmitting, by the device (e.g., 120), a recommendation (e.g., 904) to the merchant device based on the counting. In various cases, the recommendation can indicate whether the proposed team deal promotional transaction would be profitable or not profitable.

Although not explicitly shown in FIG. 16, the counting can conclude that a total number of the plurality of transactional browsing histories that correspond to first labels indicating interest in the proposed team deal promotional transaction is above a threshold value, and the recommendation can indicate that the proposed team deal promotional transaction would be profitable. In other cases, the counting can conclude that a total number of the plurality of transactional browsing histories that correspond to first labels indicating interest in the proposed team deal promotional transaction is below a threshold value, and the recommendation can indicate that the proposed team deal promotional transaction would not be profitable.

Although not explicitly shown in FIG. 16, the electronic request can indicate a proposed discount rate associated with the proposed team deal promotional transaction, and the computer-implemented method 1600 can further include: computing, by the device (e.g., 120), a different proposed discount rate that is estimated to make the proposed team deal promotional transaction profitable, and the recommendation can indicate the different proposed discount rate.

Although not explicitly shown in FIG. 16, the computer-implemented method 1600 can further include: executing, by the device (e.g., 1302), a second machine learning model (e.g., 1304) on each of the plurality of transactional browsing histories, thereby yielding a plurality of second labels (e.g., 1306) that respectively correspond to the plurality of transactional browsing histories. In various cases, a given second label that corresponds to a given transactional browsing history can indicate whether the given transactional browsing history demonstrates likely fraud or unlikely fraud with respect to the proposed team deal promotional transaction. In various instances, the counting can include counting, by the device (e.g., 120), how many of the plurality of transactional browsing histories correspond both to first labels indicating interest in the proposed team deal promotional transaction and second labels indicating unlikely fraud with respect to the proposed team deal promotional transaction.

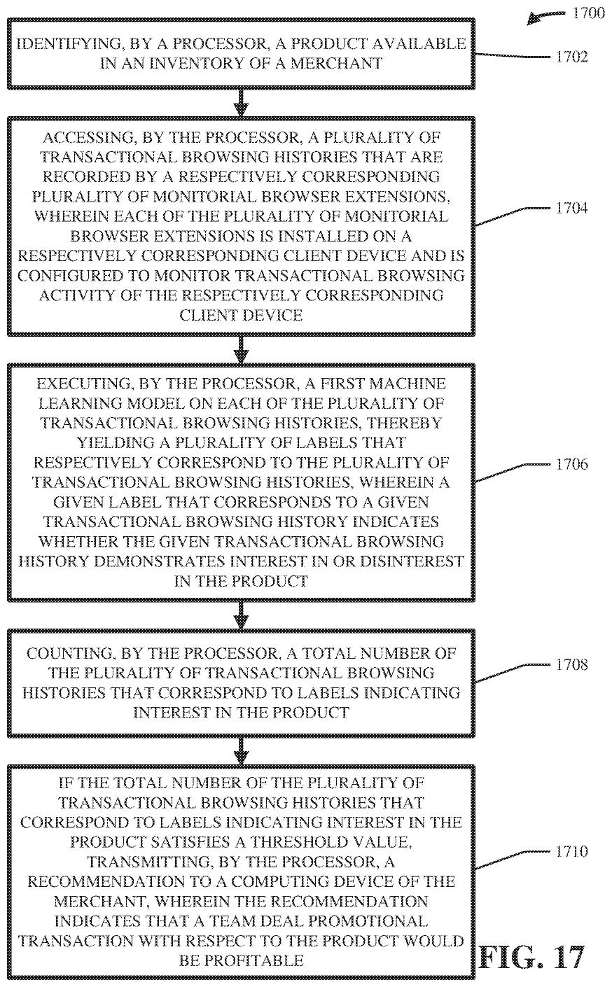

Finally, consider FIG. 17. In various embodiments, act 1702 can include identifying, by a processor (e.g., via 114), a product (e.g., 1102) available in an inventory of a merchant.

In various aspects, act 1704 can include accessing, by the processor (e.g., via 116), a plurality of transactional browsing histories (e.g., 302) that are recorded by a respectively corresponding plurality of monitorial browser extensions (e.g., 106). In various cases, each of the plurality of monitorial browser extensions can be installed on a respectively corresponding client device (e.g., one of 108) and can be configured to monitor transactional browsing activity of the respectively corresponding client device.

In various instances, act 1706 can include executing, by the processor (e.g., via 118), a first machine learning model (e.g., 502) on each of the plurality of transactional browsing histories, thereby yielding a plurality of first labels (e.g., 504) that respectively correspond to the plurality of transactional browsing histories. In various cases, a given first label that corresponds to a given transactional browsing history can indicate whether the given transactional browsing history demonstrates interest in or disinterest in the product.

In various aspects, act 1708 can include counting, by the processor (e.g., via 120), a total number of the plurality of transactional browsing histories that correspond to labels indicating interest in the product.

In various instances, act 1710 can include, if the total number of the plurality of transactional browsing histories indicating interest in the product satisfies a threshold value, transmitting, by the processor (e.g., via 120), a recommendation (e.g., 1306) to a computing device (e.g., 104) of the merchant. In various cases, the recommendation can indicate that a team deal promotional transaction with respect to the product would be profitable.

Although not explicitly shown in FIG. 17, the computer-implemented method 1700 can further include: receiving, by the processor (e.g., via 114), an electronic request from the computing device (e.g., 104) of the merchant in response to the recommendation, wherein the electronic request instructs the processor to initiate the team deal promotional transaction (e.g., 202).

Although not explicitly shown in FIG. 17, the computer-implemented method 1700 can further include: for each transactional browsing history of the plurality of transactional browsing histories that corresponds to a label indicating interest in the product, transmitting, by the processor (e.g., via 120), an electronic message (e.g., one of 702) to a client device that corresponds to the transactional browsing history. In various cases, the electronic message can invite a user of the client device to participate in the team deal promotional transaction.

Various embodiments described herein include a computerized tool that can leverage a set of monitorial browser extensions and trained machine learning classifiers to facilitate improved coordination of team deals. Such a computerized tool is certainly a useful and practical application of computers that cannot be implemented in any sensible, reasonable, and/or practical by human beings alone.

Although the herein disclosure mainly describes various embodiments in which the machine learning model 502 and/or the machine learning model 1304 execute on individual and/or single transactional browsing histories, this is a mere non-limiting example. In various aspects, those having ordinary skill in the art will appreciate that the machine learning model 502 and/or the machine learning model 1304 can execute on any suitable number of transactional browsing histories at any given time, as desired (e.g., can be configured to receive as input multiple transactional browsing histories at once).

In various instances, machine learning algorithms and/or models can be implemented in any suitable way to facilitate any suitable aspects described herein. To facilitate some of the above-described machine learning aspects of various embodiments of the subject innovation, consider the following discussion of artificial intelligence (AI). Various embodiments of the present innovation herein can employ artificial intelligence to facilitate automating one or more features of the present innovation. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) of the present innovation, components of the present innovation can examine the entirety or a subset of the data to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z₁, z₂, z₃, z₄, zₙ), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

Those having ordinary skill in the art will appreciate that the herein disclosure describes non-limiting examples of various embodiments of the subject innovation. For ease of description and/or explanation, various portions of the herein disclosure utilize the term “each” when discussing various embodiments of the subject innovation. Those having ordinary skill in the art will appreciate that such usages of the term “each” are non-limiting examples. In other words, when the herein disclosure provides a description that is applied to “each” of some particular computerized object and/or component, it should be understood that this is a non-limiting example of various embodiments of the subject innovation, and it should be further understood that, in various other embodiments of the subject innovation, it can be the case that such description applies to fewer than “each” of that particular computerized object.

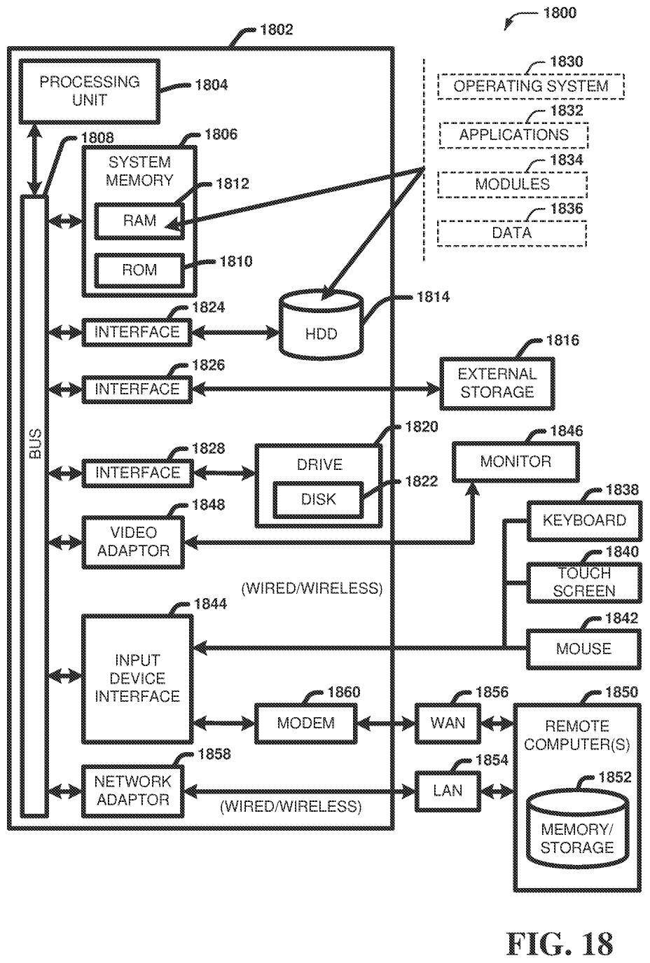

In order to provide additional context for various embodiments described herein, FIG. 18 and the following discussion are intended to provide a brief, general description of a suitable computing environment 1800 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 18, the example environment 1800 for implementing various embodiments of the aspects described herein includes a computer 1802, the computer 1802 including a processing unit 1804, a system memory 1806 and a system bus 1808. The system bus 1808 couples system components including, but not limited to, the system memory 1806 to the processing unit 1804. The processing unit 1804 can be any of various commercially available processors. Dual microprocessors and other multi-processor architectures can also be employed as the processing unit 1804.

The system bus 1808 can be any of several types of bus structure that can further interconnect to a memory bus (with or without a memory controller), a peripheral bus, and a local bus using any of a variety of commercially available bus architectures. The system memory 1806 includes ROM 1810 and RAM 1812. A basic input/output system (BIOS) can be stored in a non-volatile memory such as ROM, erasable programmable read only memory (EPROM), EEPROM, which BIOS contains the basic routines that help to transfer information between elements within the computer 1802, such as during startup. The RAM 1812 can also include a high-speed RAM such as static RAM for caching data.

The computer 1802 further includes an internal hard disk drive (HDD) 1814 (e.g., EIDE, SATA), one or more external storage devices 1816 (e.g., a magnetic floppy disk drive (FDD) 1816, a memory stick or flash drive reader, a memory card reader, etc.) and a drive 1820, e.g., such as a solid state drive, an optical disk drive, which can read or write from a disk 1822, such as a CD-ROM disc, a DVD, a BD, etc. Alternatively, where a solid state drive is involved, disk 1822 would not be included, unless separate. While the internal HDD 1814 is illustrated as located within the computer 1802, the internal HDD 1814 can also be configured for external use in a suitable chassis (not shown). Additionally, while not shown in environment 1800, a solid state drive (SSD) could be used in addition to, or in place of, an HDD 1814. The HDD 1814, external storage device(s) 1816 and drive 1820 can be connected to the system bus 1808 by an HDD interface 1824, an external storage interface 1826 and a drive interface 1828, respectively. The interface 1824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1812, including an operating system 1830, one or more application programs 1832, other program modules 1834 and program data 1836. All or portions of the operating system, applications, modules, and/or data can also be cached in the RAM 1812. The systems and methods described herein can be implemented utilizing various commercially available operating systems or combinations of operating systems.

Computer 1802 can optionally comprise emulation technologies. For example, a hypervisor (not shown) or other intermediary can emulate a hardware environment for operating system 1830, and the emulated hardware can optionally be different from the hardware illustrated in FIG. 18. In such an embodiment, operating system 1830 can comprise one virtual machine (VM) of multiple VMs hosted at computer 1802. Furthermore, operating system 1830 can provide runtime environments, such as the Java runtime environment or the .NET framework, for applications 1832. Runtime environments are consistent execution environments that allow applications 1832 to run on any operating system that includes the runtime environment. Similarly, operating system 1830 can support containers, and applications 1832 can be in the form of containers, which are lightweight, standalone, executable packages of software that include, e.g., code, runtime, system tools, system libraries and settings for an application.

Further, computer 1802 can be enable with a security module, such as a trusted processing module (TPM). For instance with a TPM, boot components hash next in time boot components, and wait for a match of results to secured values, before loading a next boot component. This process can take place at any layer in the code execution stack of computer 1802, e.g., applied at the application execution level or at the operating system (OS) kernel level, thereby enabling security at any level of code execution.

A user can enter commands and information into the computer 1802 through one or more wired/wireless input devices, e.g., a keyboard 1838, a touch screen 1840, and a pointing device, such as a mouse 1842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1804 through an input device interface 1844 that can be coupled to the system bus 1808, but can be connected by other interfaces, such as a parallel port, an IEEE 1394 serial port, a game port, a USB port, an IR interface, a BLUETOOTH® interface, etc.

A monitor 1846 or other type of display device can be also connected to the system bus 1808 via an interface, such as a video adapter 1848. In addition to the monitor 1846, a computer typically includes other peripheral output devices (not shown), such as speakers, printers, etc.

The computer 1802 can operate in a networked environment using logical connections via wired and/or wireless communications to one or more remote computers, such as a remote computer(s) 1850. The remote computer(s) 1850 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1852 is illustrated. The logical connections depicted include wired/wireless connectivity to a local area network (LAN) 1854 and/or larger networks, e.g., a wide area network (WAN) 1856. Such LAN and WAN networking environments are commonplace in offices and companies, and facilitate enterprise-wide computer networks, such as intranets, all of which can connect to a global communications network, e.g., the Internet.

When used in a LAN networking environment, the computer 1802 can be connected to the local network 1854 through a wired and/or wireless communication network interface or adapter 1858. The adapter 1858 can facilitate wired or wireless communication to the LAN 1854, which can also include a wireless access point (AP) disposed thereon for communicating with the adapter 1858 in a wireless mode.

When used in a WAN networking environment, the computer 1802 can include a modem 1860 or can be connected to a communications server on the WAN 1856 via other means for establishing communications over the WAN 1856, such as by way of the Internet. The modem 1860, which can be internal or external and a wired or wireless device, can be connected to the system bus 1808 via the input device interface 1844. In a networked environment, program modules depicted relative to the computer 1802 or portions thereof, can be stored in the remote memory/storage device 1852. It will be appreciated that the network connections shown are example and other means of establishing a communications link between the computers can be used.

When used in either a LAN or WAN networking environment, the computer 1802 can access cloud storage systems or other network-based storage systems in addition to, or in place of, external storage devices 1816 as described above, such as but not limited to a network virtual machine providing one or more aspects of storage or processing of information. Generally, a connection between the computer 1802 and a cloud storage system can be established over a LAN 1854 or WAN 1856 e.g., by the adapter 1858 or modem 1860, respectively. Upon connecting the computer 1802 to an associated cloud storage system, the external storage interface 1826 can, with the aid of the adapter 1858 and/or modem 1860, manage storage provided by the cloud storage system as it would other types of external storage. For instance, the external storage interface 1826 can be configured to provide access to cloud storage sources as if those sources were physically connected to the computer 1802.

The computer 1802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

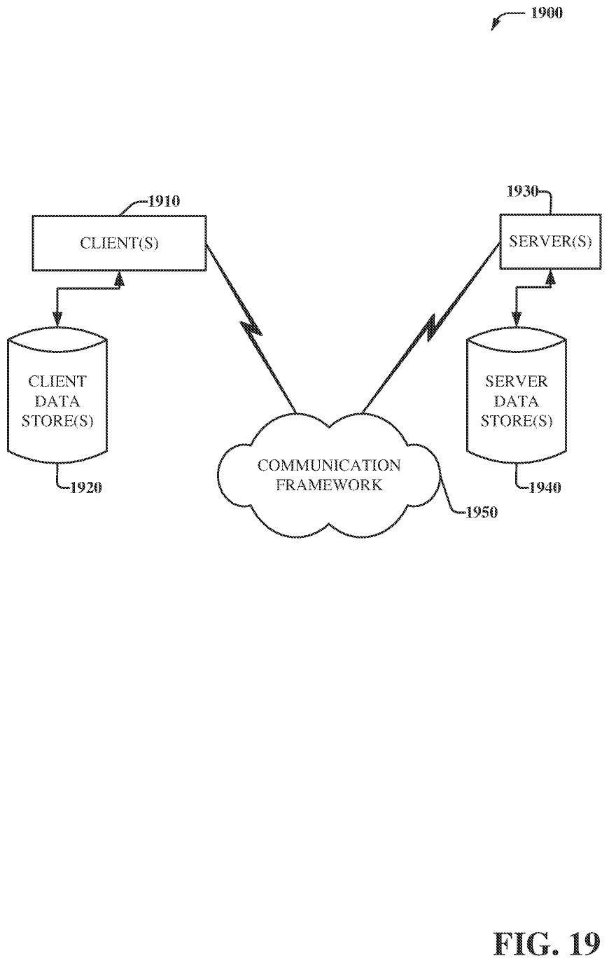

FIG. 19 is a schematic block diagram of a sample computing environment 1900 with which the disclosed subject matter can interact. The sample computing environment 1900 includes one or more client(s) 1910. The client(s) 1910 can be hardware and/or software (e.g., threads, processes, computing devices). The sample computing environment 1900 also includes one or more server(s) 1930. The server(s) 1930 can also be hardware and/or software (e.g., threads, processes, computing devices). The servers 1930 can house threads to perform transformations by employing one or more embodiments as described herein, for example. One possible communication between a client 1910 and a server 1930 can be in the form of a data packet adapted to be transmitted between two or more computer processes. The sample computing environment 1900 includes a communication framework 1950 that can be employed to facilitate communications between the client(s) 1910 and the server(s) 1930. The client(s) 1910 are operably connected to one or more client data store(s) 1920 that can be employed to store information local to the client(s) 1910. Similarly, the server(s) 1930 are operably connected to one or more server data store(s) 1940 that can be employed to store information local to the servers 1930.

Various embodiments described herein may be a system, a method, an apparatus and/or a computer program product at any possible technical detail level of integration. The computer program product can include a computer readable storage medium (or media) having computer readable program instructions thereon for causing a processor to carry out aspects of various embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments described herein can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of various embodiments described herein.

Aspects of various embodiments are described herein with reference to flowchart illustrations and/or block diagrams of methods, apparatus (systems), and computer program products according to various embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments described herein. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-8. (canceled)

9. A computer-implemented method, comprising:
receiving, by a device operatively coupled to a processor, an electronic request from a merchant device, wherein the electronic request identifies a proposed team deal promotional transaction;
accessing, by the device, a plurality of transactional browsing histories that are recorded by a respectively corresponding plurality of monitorial browser extensions, wherein each of the plurality of monitorial browser extensions is installed on a respectively corresponding client device and is configured to monitor transactional browsing activity of the respectively corresponding client device;
executing, by the device, a first machine learning model on each of the plurality of transactional browsing histories, thereby yielding a plurality of first labels that respectively correspond to the plurality of transactional browsing histories, wherein a given first label that corresponds to a given transactional browsing history indicates whether the given transactional browsing history demonstrates interest in or disinterest in the proposed team deal promotional transaction;
counting, by the device, how many of the plurality of transactional browsing histories correspond to first labels indicating interest in the proposed team deal promotional transaction; and
transmitting, by the device, a recommendation to the merchant device based on the counting, wherein the recommendation indicates whether the proposed team deal promotional transaction would be profitable or not profitable.

10. The computer-implemented method of claim 9, wherein the counting concludes that a total number of the plurality of transactional browsing histories that correspond to first labels indicating interest in the proposed team deal promotional transaction is above a threshold value, and wherein the recommendation indicates that the proposed team deal promotional transaction would be profitable.

11. The computer-implemented method of claim 9, wherein the counting concludes that a total number of the plurality of transactional browsing histories that correspond to first labels indicating interest in the proposed team deal promotional transaction is below a threshold value, and wherein the recommendation indicates that the proposed team deal promotional transaction would not be profitable.

12. The computer-implemented method of claim 11, wherein the electronic request indicates a proposed discount rate associated with the proposed team deal promotional transaction, and further comprising:
computing, by the device, a different proposed discount rate that is estimated to make the proposed team deal promotional transaction profitable, wherein the recommendation indicates the different proposed discount rate.

13. The computer-implemented method of claim 9, further comprising:
executing, by the device, a second machine learning model on each of the plurality of transactional browsing histories, thereby yielding a plurality of second labels that respectively correspond to the plurality of transactional browsing histories, wherein a given second label that corresponds to a given transactional browsing history indicates whether the given transactional browsing history demonstrates likely fraud or unlikely fraud with respect to the proposed team deal promotional transaction.

14. The computer-implemented method of claim 13, wherein the counting includes counting, by the device, how many of the plurality of transactional browsing histories correspond both to first labels indicating interest in the proposed team deal promotional transaction and second labels indicating unlikely fraud with respect to the proposed team deal promotional transaction.

15. The computer-implemented method of claim 9, wherein each of the plurality of monitorial browser extensions is installed on a respectively corresponding client device and is configured to monitor transactional browsing activity across two or more websites visited by the respectively corresponding client device.

16. The computer-implemented method of claim 9, wherein the electronic request from the merchant device specifies a product or service associated with the proposed team deal promotional transaction, a price discount associated with the proposed team deal promotional transaction, or a minimum number of participants required for the proposed team deal promotional transaction.

17. A computer program product for facilitating automatically coordinated social buying via monitorial browser extensions, the computer program product comprising a computer-readable medium having program instructions embodied therewith, the program instructions executable by a processor to cause the processor to perform operations comprising:
identifying, by the processor, a product available in an inventory of a merchant;
accessing, by the processor, a plurality of transactional browsing histories that are recorded by a respectively corresponding plurality of monitorial browser extensions, wherein each of the plurality of monitorial browser extensions is installed on a respectively corresponding client device and is configured to monitor transactional browsing activity of the respectively corresponding client device;
executing, by the processor, a first machine learning model on each of the plurality of transactional browsing histories, thereby yielding a plurality of labels that respectively correspond to the plurality of transactional browsing histories, wherein a given label that corresponds to a given transactional browsing history indicates whether the given transactional browsing history demonstrates interest in or disinterest in the product;
counting, by the processor, a total number of the plurality of transactional browsing histories that correspond to labels indicating interest in the product; and
if the total number of the plurality of transactional browsing histories that correspond to labels indicating interest in the product satisfies a threshold value, transmitting, by the processor, a recommendation to a computing device of the merchant, wherein the recommendation indicates that a team deal promotional transaction with respect to the product would be profitable.

18. The computer program product of claim 17, wherein the operations further comprise:
receiving, by the processor, an electronic request from the computing device of the merchant in response to the recommendation, wherein the electronic request instructs the processor to initiate the team deal promotional transaction.

19. The computer program product of claim 18, wherein the operations further comprise:
for each transactional browsing history of the plurality of transactional browsing histories that corresponds to a label indicating interest in the product, transmitting, by the processor, an electronic message to a client device that corresponds to the transactional browsing history, wherein the electronic message invites a user of the client device to participate in the team deal promotional transaction.

20. The computer program product of claim 17, wherein each of the plurality of monitorial browser extensions is installed on a respectively corresponding client device and is configured to monitor transactional browsing activity across two or more websites visited by the respectively corresponding client device.

21. A computer system, comprising:
a processor; and
a non-transitory computer-readable medium having stored thereon instructions that are executable by the processor to cause the system to perform operations comprising:
receiving, by the computer system, an electronic request from a merchant device, wherein the electronic request identifies a proposed team deal promotional transaction;
accessing, by the computer system, a plurality of transactional browsing histories of respective corresponding client devices;
generating, by the computer system, a plurality of first labels that respectively correspond to the plurality of transactional browsing histories, wherein a given first label that corresponds to a given transactional browsing history indicates whether the given transactional browsing history demonstrates interest in or disinterest in the proposed team deal promotional transaction;
counting, by the computer system, how many of the plurality of transactional browsing histories correspond to first labels indicating interest in the proposed team deal promotional transaction; and
transmitting, by the computer system, a recommendation to the merchant device based on the counting, wherein the recommendation indicates whether the proposed team deal promotional transaction would be profitable or not profitable.

22. The computer system of claim 21, wherein the counting concludes that a total number of the plurality of transactional browsing histories that correspond to first labels indicating interest in the proposed team deal promotional transaction is above a threshold value, and wherein the recommendation indicates that the proposed team deal promotional transaction would be profitable.

23. The computer system of claim 21, wherein the counting concludes that a total number of the plurality of transactional browsing histories that correspond to first labels indicating interest in the proposed team deal promotional transaction is below a threshold value, and wherein the recommendation indicates that the proposed team deal promotional transaction would not be profitable.

24. The computer system of claim 23, wherein the electronic request indicates a proposed discount rate associated with the proposed team deal promotional transaction, and wherein the operations further comprise:
computing, by the computer system, a different proposed discount rate that is estimated to make the proposed team deal promotional transaction profitable, wherein the recommendation indicates the different proposed discount rate.

25. The computer system of claim 21, wherein generating the plurality of first labels comprises executing a first machine learning model on each of the plurality of transactional browsing histories.

26. The computer system of claim 25, wherein the operations further comprise:
executing, by the computer system, a second machine learning model on each of the plurality of transactional browsing histories, thereby yielding a plurality of second labels that respectively correspond to the plurality of transactional browsing histories, wherein a given second label that corresponds to a given transactional browsing history indicates whether the given transactional browsing history demonstrates likely fraud or unlikely fraud with respect to the proposed team deal promotional transaction.

27. The computer system of claim 26, wherein the counting includes counting, by the computer system, how many of the plurality of transactional browsing histories correspond both to first labels indicating interest in the proposed team deal promotional transaction and second labels indicating unlikely fraud with respect to the proposed team deal promotional transaction.

28. The computer system of claim 21, wherein the electronic request from the merchant device specifies a product or service associated with the proposed team deal promotional transaction, a price discount associated with the proposed team deal promotional transaction, or a minimum number of participants required for the proposed team deal promotional transaction.
